(19) United States
(12) Patent Application Publication
(10) Pub. No.: US 2026/0170755 A1
(43) Pub. Date: Jun. 18, 2026

(54) GENERATING THREE-DIMENSIONAL REPRESENTATIONS

(71) Applicant: QUALCOMM Incorporated, San Diego, CA (US)

(72) Inventors: Georgi DIKOV, Amsterdam (NL); Mohsen GHAFOORIAN, Diemen (NL); Jihong JU, Amsterdam (NL)

(21) Appl. No.: 19/384,843

(22) Filed: Nov. 10, 2025

Related U.S. Application Data
(60) Provisional application No. 63/735,859, filed on Dec. 18, 2024.

(51) Int. Cl. G06T 17/00; G06T 7/70; G06T 15/06

(52) U.S. Cl. CPC G06T 17/00; G06T 7/70; G06T 15/06

(57) ABSTRACT

Systems and techniques are described herein for generating three-dimensional (3D) data. For instance, a method is provided. The method may include obtaining a plurality of images of a scene; obtaining a plurality of camera poses, wherein each image of the plurality of images is captured from a corresponding camera pose of the plurality of camera poses, each camera pose comprising a position and an orientation; determining a plurality of 3D points based on the plurality of camera poses, wherein each 3D point of the plurality of 3D points corresponds to a camera pose of the plurality of camera poses; selecting a subset of the plurality of images based on positions of the plurality of camera poses and the plurality of 3D points; and generating a 3D representation of the scene based on the subset of the plurality of images and a corresponding subset of the plurality of camera poses.

### CROSS-REFERENCE TO RELATED APPLICATIONS

This application claims the benefit of U.S. Provisional Application No. 63/735,859, filed Dec. 18, 2024, which is incorporated herein by reference in its entirety.

### TECHNICAL FIELD

The present disclosure generally relates to three-dimensional (3D) representations. For example, aspects of the present disclosure include systems and techniques for generating 3D representations of objects, scenes, and/or people.

### BACKGROUND

Three-dimensional (3D)-reconstruction (3DR) techniques may generate 3D representations (e.g., 3D models) of objects, scenes (e.g., a room or an interior of a building) and/or people. Some 3DR techniques may generate a 3D model (e.g., a point-cloud model, a Gaussian-splat model, a voxel model, or a mesh-based model) of a scene based on images of objects, scenes, or people.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating three-dimensional (3D) data. According to at least one example, a method is provided for generating three-dimensional (3D) data. The method includes: obtaining a plurality of images of a scene; obtaining a plurality of camera poses, wherein each image of the plurality of images is captured from a corresponding camera pose of the plurality of camera poses, and wherein each camera pose of the plurality of camera poses comprises a respective position and a respective orientation; determining a plurality of 3D points based on the plurality of camera poses, wherein each 3D point of the plurality of 3D points corresponds to a camera pose of the plurality of camera poses; selecting a subset of the plurality of images based on positions of the plurality of camera poses and the plurality of 3D points; and generating a 3D representation of the scene based on the subset of the plurality of images and a corresponding subset of the plurality of camera poses.

In another example, an apparatus for generating three-dimensional (3D) data is provided that includes at least one memory and at least one processor (e.g., configured in circuitry) coupled to the at least one memory. The at least one processor configured to: obtain a plurality of images of a scene; obtain a plurality of camera poses, wherein each image of the plurality of images is captured from a corresponding camera pose of the plurality of camera poses, and wherein each camera pose of the plurality of camera poses comprises a respective position and a respective orientation; determine a plurality of 3D points based on the plurality of camera poses, wherein each 3D point of the plurality of 3D points corresponds to a camera pose of the plurality of camera poses; select a subset of the plurality of images based on positions of the plurality of camera poses and the plurality of 3D points; and generate a 3D representation of the scene based on the subset of the plurality of images and a corresponding subset of the plurality of camera poses.

In another example, a non-transitory computer-readable medium is provided that has stored thereon instructions that, when executed by one or more processors, cause the one or more processors to: obtain a plurality of images of a scene; obtain a plurality of camera poses, wherein each image of the plurality of images is captured from a corresponding camera pose of the plurality of camera poses, and wherein each camera pose of the plurality of camera poses comprises a respective position and a respective orientation; determine a plurality of 3D points based on the plurality of camera poses, wherein each 3D point of the plurality of 3D points corresponds to a camera pose of the plurality of camera poses; select a subset of the plurality of images based on positions of the plurality of camera poses and the plurality of 3D points; and generate a 3D representation of the scene based on the subset of the plurality of images and a corresponding subset of the plurality of camera poses.

In another example, an apparatus for generating three-dimensional (3D) data is provided. The apparatus includes: means for obtaining a plurality of images of a scene; means for obtaining a plurality of camera poses, wherein each image of the plurality of images is captured from a corresponding camera pose of the plurality of camera poses, and wherein each camera pose of the plurality of camera poses comprises a respective position and a respective orientation; means for determining a plurality of 3D points based on the plurality of camera poses, wherein each 3D point of the plurality of 3D points corresponds to a camera pose of the plurality of camera poses; means for selecting a subset of the plurality of images based on positions of the plurality of camera poses and the plurality of 3D points; and means for generating a 3D representation of the scene based on the subset of the plurality of images and a corresponding subset of the plurality of camera poses.

In another example, a method is provided for generating three-dimensional (3D) data. The method includes: processing an input image of a scene using an uncertainty predictor to predict a plurality of uncertainty values; querying an implicit neural representation, based on the input image, a camera pose associated with the input image, and the plurality of uncertainty values to generate model outputs; generating a representation of the scene based on the model outputs; determining an error based on a comparison between the input image and the representation; modifying parameters of the implicit neural representation based on the error; and modifying parameters of the uncertainty predictor based on the error.

In another example, an apparatus for generating three-dimensional (3D) data is provided that includes at least one memory and at least one processor (e.g., configured in circuitry) coupled to the at least one memory. The at least one processor configured to: process an input image of a scene using an uncertainty predictor to predict a plurality of uncertainty values; query an implicit neural representation, based on the input image, a camera pose associated with the input image, and the plurality of uncertainty values to generate model outputs; generate a representation of the scene based on the model outputs; determine an error based on a comparison between the input image and the representation; modify parameters of the implicit neural representation based on the error; and modify parameters of the uncertainty predictor based on the error.

In another example, a non-transitory computer-readable medium is provided that has stored thereon instructions that, when executed by one or more processors, cause the one or more processors to: process an input image of a scene using an uncertainty predictor to predict a plurality of uncertainty values; query an implicit neural representation, based on the input image, a camera pose associated with the input image, and the plurality of uncertainty values to generate model outputs; generate a representation of the scene based on the model outputs; determine an error based on a comparison between the input image and the representation; modify parameters of the implicit neural representation based on the error; and modify parameters of the uncertainty predictor based on the error.

In another example, an apparatus for generating three-dimensional (3D) data is provided. The apparatus includes: means for processing an input image of a scene using an uncertainty predictor to predict a plurality of uncertainty values; means for querying an implicit neural representation, based on the input image, a camera pose associated with the input image, and the plurality of uncertainty values to generate model outputs; means for generating a representation of the scene based on the model outputs; means for determining an error based on a comparison between the input image and the representation; means for modifying parameters of the implicit neural representation based on the error; and means for modifying parameters of the uncertainty predictor based on the error.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A is a diagram illustrating an example system for generating 3D representations and/or 2D representations based on training data (including images), according to various aspects of the present disclosure;

FIG. 1B includes example visual depictions of example instances of training data, a 3D representation, and 2D representations, according to various aspects of the present disclosure;

FIG. 2 includes a 3D graph of positions of camera poses within a 3D space;

FIG. 3 includes a 3D graph including example camera poses;

FIG. 4 includes a 3D graph including example camera poses;

FIG. 5 includes a 3D graph including camera poses, sampled according to various aspects of the present disclosure;

FIG. 6A includes an illustration of a camera and a 3D point projected in front of camera, according to various aspects of the present disclosure;

FIG. 6B includes an illustration of the camera of FIG. 6A in a different pose, according to various aspects of the present disclosure;

FIG. 7 is a block diagram of an example system for generating a 3D representation based on images, according to various aspects of the present disclosure;

FIG. 8 is a block diagram illustrating an example system for generating 3D representations and/or 2D representations, according to various aspects of the present disclosure;

FIG. 9 includes example 2D representations, according to various aspects of the present disclosure;

FIG. 10 is a block diagram illustrating a system for training a machine-learning model, according to various aspects of the present disclosure;

FIG. 11 illustrates a simulated ray projected through pixel of an image of a simulated image plane into a simulated three-dimensional volume, according to various aspects of the present disclosure;

FIG. 12 is a block diagram illustrating a machine-learning model, according to various aspects of the present disclosure;

FIG. 13 illustrates an example three-dimensional model to provide context for a description of generating the three-dimensional model, according to various aspects of the present disclosure;

FIG. 14 is a diagram illustrating an example system for generating Gaussian splats;

FIG. 15 is a diagram illustrating an example of a scene that has been modeled as a 3D sparse volumetric representation for 3DR;

FIG. 16 is a diagram illustrating an example of a hash map lookup type of volume block representation;

FIG. 17 is a diagram illustrating an example of a volume block;

FIG. 18 is a diagram illustrating an example of a TSDF volume reconstruction;

FIG. 19 is a diagram of an example voxel block selection algorithm for 3DR of a scene;

FIG. 20 is a flow diagram illustrating an example process for generating a 3D representation, in accordance with aspects of the present disclosure;

FIG. 21 is a flow diagram illustrating an example process for generating a 3D representation, in accordance with aspects of the present disclosure;

FIG. 22 is a block diagram illustrating an example of a deep learning neural network that can be used to perform various tasks, according to some aspects of the disclosed technology;

FIG. 23 is a block diagram illustrating an example of a convolutional neural network (CNN), according to various aspects of the present disclosure; and

FIG. 24 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, three-dimensional (3D)-reconstruction (3DR) techniques may generate 3D representations (e.g., 3D models) of objects, scenes (e.g., a room or an interior of a building) and/or people. For example, a 3DR technique may generate a 3D representation of a scene including objects. As another example, a 3DR technique may generate a 3D representation of a person (e.g., a 3D avatar) or an object. Some 3DR techniques may generate a 3D model (e.g., a point-cloud model, a Gaussian-splat model, a voxel model, or a mesh-based model) of a scene based on images of objects, scenes, and/or people.

One technique for generating a 3D representation of a scene may include capturing a number of images of the scene from a number of respective poses (e.g., positions and/or orientations) within the scene. The number of images may be used to generate an implicit neural representation of the scene by projecting rays through pixels of the images of the scene and querying the implicit neural representation for information, such as opacity, color, truncated signed distance function (TSDF), of points along the ray. The implicit neural representation may return values (e.g., indicative of the opacity color, and/or TSDF). The values may be used to render the 3D representation. Images of the 3D representation may be simulated. The simulated images may be compared to the captured images. The implicit neural representation may be revised based on the differences between the simulated images and the captured images. Over a number of iterations of querying, rendering, comparing, and revising, the implicit neural representation may improve and over time, the implicit neural representation may represent the scene. One example of such an implicit neural representation is referred to as a Neural Radiance Field (NeRF).

Other techniques (for example, Gaussian splatting and TSDF-volume generation) may use images of objects, scenes, and/or people to generate 3D representations of the objects, scenes, and/or people.

Systems, apparatuses, methods (also referred to as processes), and computer-readable media (collectively referred to herein as “systems and techniques”) are described herein for generating 3D representations. For example, the systems and techniques described herein may obtain images and generate a 3D representation based on the images.

In some aspects, the systems and techniques may obtain a plurality of images of objects, scenes, and/or people. The systems and techniques may select a subset of the plurality of images and generate a 3D representation of the objects, scenes, and/or people based on the selected subset of images. Such systems and techniques may be used to improve many different 3DR techniques, such as generating implicit neural representations, such as NeRFs, Gaussian splatting, and/or TSDF-volume generation.

In some aspects, the systems and techniques may, while generating an implicit neural representation of objects, scenes, and/or people, identify image pixels of the training data that relate to uncertainty with regard to depth and/or normals. The systems and techniques may select the uncertain pixels and project rays from the uncertain pixels when querying the implicit neural representation. This may improve the training of the implicit neural representation with regard to challenging portions of the objects, scenes, and/or people.

The systems and techniques may lead to better training times and/or better 2D rendered results and 3D reconstructed structures. For example, the systems and techniques may allow a 3DR technique to generate a representation of objects, scenes, and/or peoples faster than other techniques. Additionally or alternatively, the systems and techniques may allow a 3DR technique to generate a more accurate and/or more detailed representation of objects, scenes, and/or people than is generated by other techniques.

Various aspects of the application will be described with respect to the figures below.

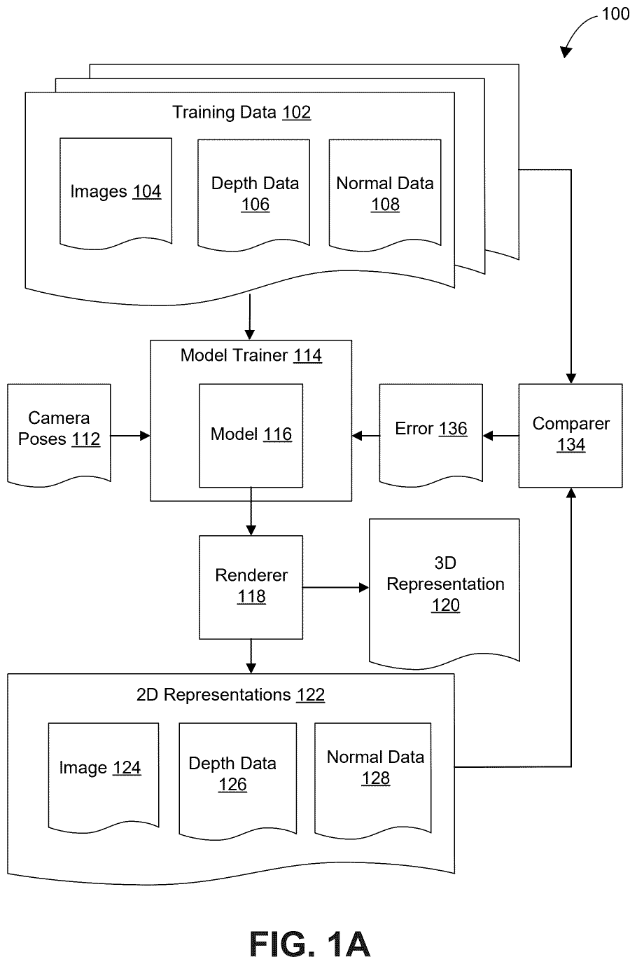

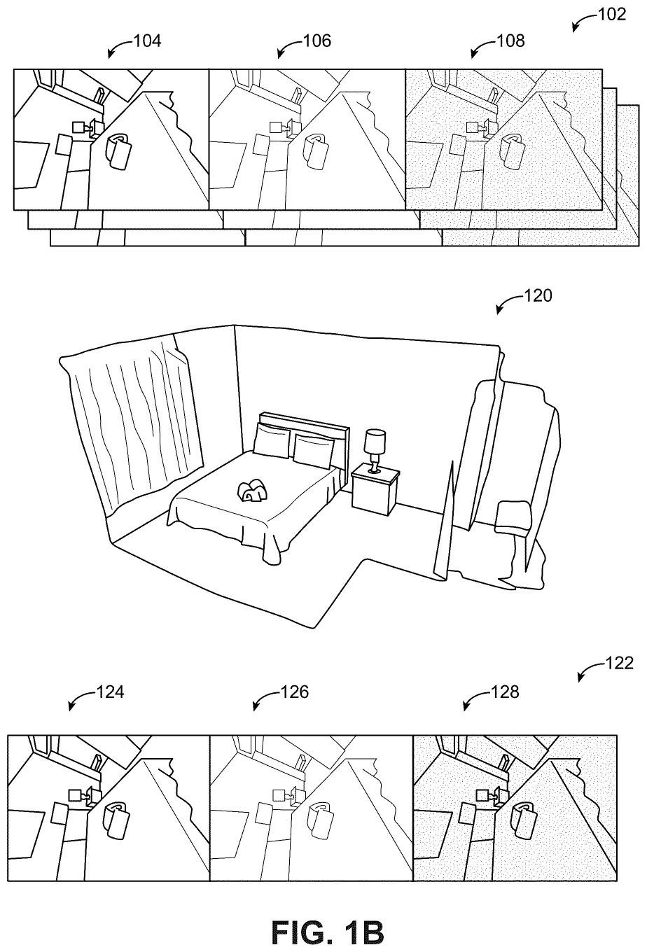

FIG. 1A is a diagram illustrating an example system 100 for generating 3D representation 120 and/or 2D representations 122 based on training data 102, according to various aspects of the present disclosure. System 100 may train a model 116 as an implicit neural representation of objects, scenes, and/or people. Renderer 118 may render a 3D representation 120 and/or 2D representations 122 based on model 116.

Training data 102 may be, or may include, images 104 of objects, scenes, and/or people. Training data 102 may include many (e.g., tens, hundreds, or thousands of) images 104. Various ones of images 104 may be captured from different poses (e.g., positions and orientations) relative to the objects, scenes, and/or peoples.

Camera poses 112 may be, or may include, a position and an orientation of a camera (or cameras) that captures images 104. For example, camera poses 112 may include a position and an orientation from which each of images 104 is captured.

In some aspects, training data 102 may include depth data 106 and/or normal data 108. Depth data 106 and/or normal data 108 may be based on images 104. For example, a monocular depth-estimation model may predict depth data 106 based on images 104. Additionally or alternatively, a normal predictor may predict normal data 108 based on images 104. In the present disclosure, the term “depth” may refer to a distance between a point in a scene and camera (or other device) which captured an image (or other representation) of the scene. In the present disclosure, the term “normal” may refer to a vector orthogonal to a surface.

Model trainer 114 may iteratively generate model 116 based on training data 102 and camera poses 112. For example, model trainer 114 may iteratively modify parameters (e.g., weights) of model 116 to cause model 116 to implicitly represent objects, scenes, and/or people depicted by images 104.

Model 116 may be, or may include, an implicit neural representation of objects, scenes, and/or peoples represented by training data 102. Model 116 may be, or may include, a NeRF. Additionally or alternatively, model 116 may be, or may include, a signed distance function (SDF), such as a MonoSDF. As another example, model 116 may be, or may include, an Occ-SDF.

Model trainer 114 may project rays through pixels of images 104 and query the model 116 for information, such as opacity, color, truncated signed distance function (TSDF), of points along the ray. The model 116 may return values (e.g., indicative of the opacity, color, and/or TSDF). The values may be used to render a provisional 3D representation of the objects, scenes, and/or people (e.g., a provisional instance of 3D representation 120). Renderer 118 may simulate images of the provisional instance of 3D representation 120 from poses corresponding to camera poses 112 (e.g., to generate provisional instances of 2D representations 122). Comparer 134 may compare the simulated images (e.g., the provisional instances of 2D representations 122) with images 104 and determine error 136 based on the differences. Error 136 may be based on the differences between training data 102 and 2D representations 122. Model trainer 114 may revise model 116 based on error 136. Over a number of iterations of querying, rendering, comparing, and revising, model trainer 114 may improve model 116. Over time, model 116 may represent the objects, scenes, and/or people.

During the training of model 116, model trainer 114 may project a number of rays from a camera center of one of camera poses 112 through a number of pixels of each of images 104 to create 3D query points along the rays. The pixels may be randomly sampled. Model trainer 114 may give each of the query points as input to a multi-layer perceptron (MLP) (e.g., model 116), which predicts an SDF value, color, and/or opacity. Further model trainer 114 may integrate the points along each ray into a “rendered” color, depth, and/or normal. Comparer 134 may determine a loss between the rendered pixels and the target pixels.

Once model trainer 114 has trained model 116 (e.g., once model 116 reaches convergence), renderer 118 may render a final instances of 3D representation 120 and/or 2D representations 122 and output the final instance of 3D representation 120 and/or 2D representations 122. For example, renderer 118 may render model 116 as 3D representation 120. For example, renderer 118 may querier each point of a 3D space and build 3D representation 120 based on the responses of model 116. Additionally renderer 118 may generate 2D representations 122 based on model 116. For example, renderer 118 may generate 2D representations 122 from a simulated position within a scene. 2D representations 122 may include, for example, image 124, depth data 126, and/or normal data 128.

The above-described steps may be repeated until model 116 converges. It may take hundreds or thousands of iterations, over thousands of rays, each sampling thousands of points. It may take a hours or days to train a model (e.g., model 116) to represent a scene using, for example, one graphics processing unit (GPU) with 20 gigabytes (GB) of memory.

Since such a computation is a large investment, it is expected that this method yields high quality results on a variety of scenes. This however is not guaranteed as some environments can be very challenging.

Additionally, the results of the optimization of the model may be sensitive to the training data. If scene coverage is poor (e.g., images 104 do not uniformly represent a scene), many parts would not be well reconstructed and 2D renderings may be noisy and/or inaccurate.

FIG. 1B includes example visual depictions of example instances of training data 102, images 104, depth data 106, normal data 108, 3D representation 120, 2D representations 122, image 124, depth data 126, and normal data 128.

The systems and techniques, according to various aspects of the present disclosure, may select images to use to train a model to represent objects, scenes, and/or people. For example, the systems and techniques may include selecting images from among a plurality of images to select substantially uniformly representative of the objects, scenes, and/or people.

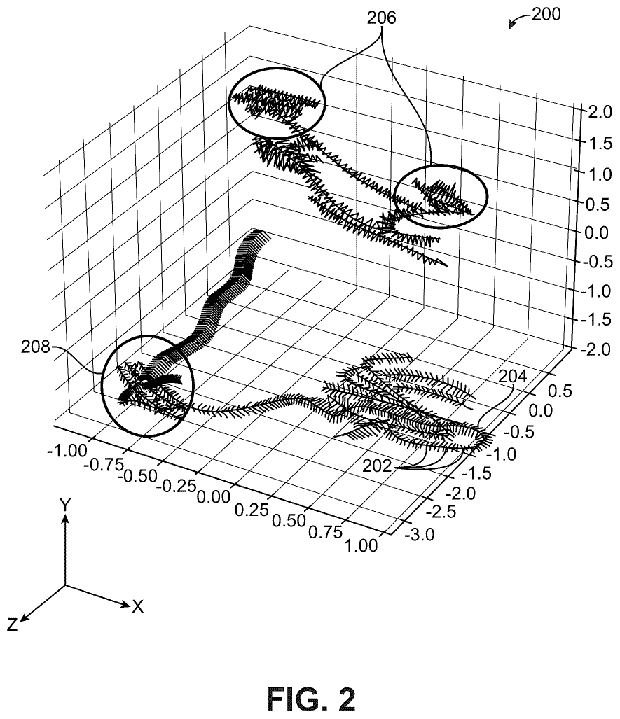

FIG. 2 includes a 3D graph 200 including camera poses 202 within a 3D space. For example, an example camera pose 204 of camera poses 202 may have position coordinates [1.0, −2.0, −1.0] according to an example x, y, z, coordinate system of the 3D space. Poses (e.g, camera poses) include three positional coordinates (e.g., x, y, and z) and three rotational angles (e.g., roll, pitch, and yaw). FIG. 2 illustrates the camera pose as a pyramid, where the vertex is the camera origin and the orientation of the edges represent the camera frustum.

Camera poses 202 may represent poses in a scene from which images of the scene were captured. The images of the scene may be used to train a model to represent the scene (e.g., as described with regard to FIG. 1A). For example, camera poses 202 may be examples of camera poses 112.

Some models (e.g., model 116) may be trained using 100 to 1000 images of a scene. To learn a scene well, the images used to train a model should adequately cover the scene.

A user may use a video camera to capture images of a scene. The video camera may capture images at a rate of 30 or 60 frames per second (fps). As the user capture video, the user may spend more time in one portion of the scene and move quickly through another portion of the scene, creating a spatial bias in the distribution of images.

For example, as illustrated by camera poses 202, there may be clusters 206 of camera poses in certain portions of the scene (indicating that many images were captured from camera poses of clusters 206) and relatively few camera poses in other portions of the scene (indicating that relatively few images were captured in the other portions of the scene). Such clusters 206 may result in biased training of a model. Additionally or alternatively, gaps (e.g., areas without or with relatively few camera poses from which images were captured) may result in incomplete or inaccurate representations of the scene.

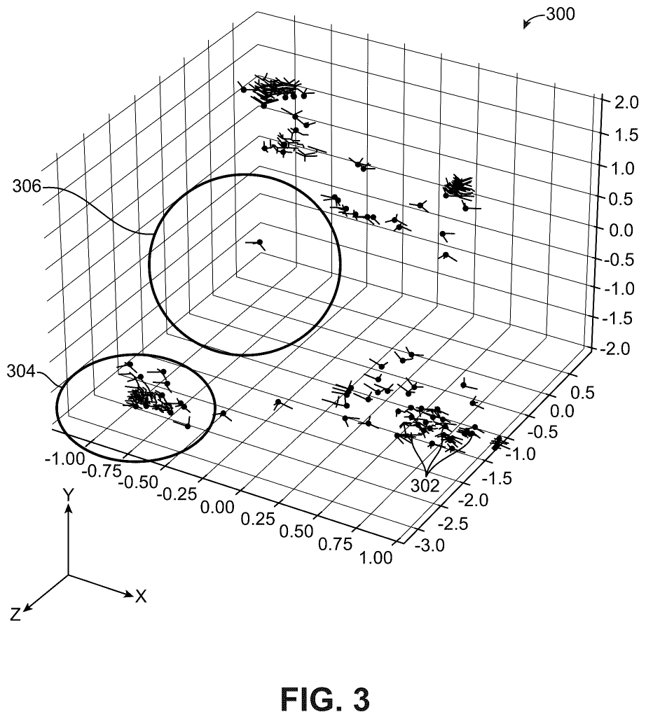

One way to address such a sampling bias is to randomly, or temporally-uniformly, sample images. For example, FIG. 3 includes a 3D graph 300 including camera poses 302. Camera poses 302 may be a sampled set of camera poses 202. For example, camera poses 202 may include 3500 camera poses. camera poses 302 may include 350 camera poses sampled from among camera poses 202. For example, camera poses 302 may include every 10th camera pose from among camera poses 202. As another example, camera poses 302 may include a randomly-selected 350 camera poses from among camera poses 202.

Training a model based on images corresponding to camera poses 302 (e.g., as compared to training a model based on images corresponding to camera poses 202) may result in less biasing of the model based on clusters, for example, at clusters 206. For example, there are fewer camera poses 302 in cluster 304 than there are in cluster 208. However, there are few camera poses 302 in sparse region 306 which may result in poor training of the model with regard to portions of the scene visible from sparse region 306.

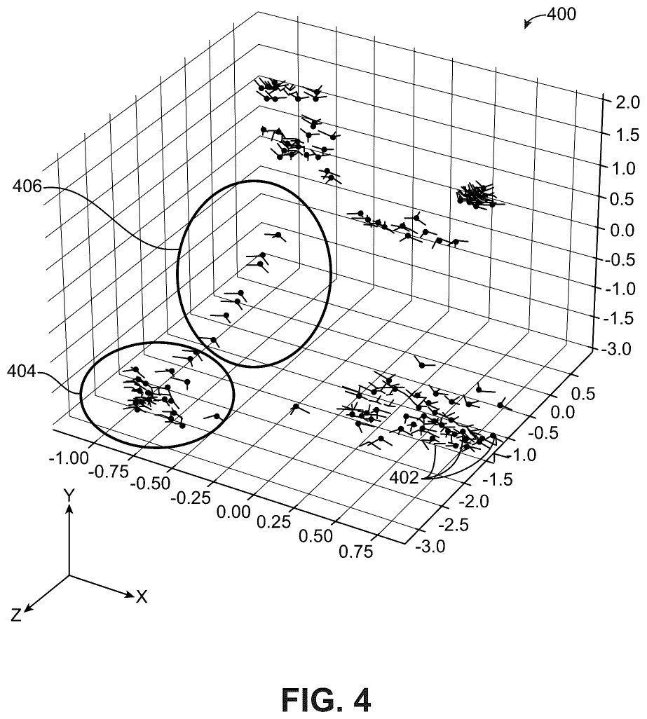

Another way to address sampling bias is to sample images based on spatial differences between the camera poses. For example, FIG. 4 includes a 3D graph 400 including camera poses 402. Camera poses 402 may be a sampled set of camera poses 202. For example, camera poses 402 may be sampled from among camera poses 202 based on a pose of the camera having changed beyond a movement threshold between sampled camera poses. For example, a first camera pose of camera poses 202 may be included in camera poses 402. The next camera pose that is different from the first camera pose by a threshold distance and/or orientation may be selected from inclusion in camera poses 402. Comparing camera poses 402 to camera poses 302, camera poses 402 may include more camera poses in sparse region 406 than camera poses 302 includes in sparse region 306.

Motion-based sampling (e.g., using minimum reorientation and/or translation thresholds) can cause images in sparse regions (e.g., sparse region 406) to be sampled. However, to avoid dropping too many frames, motion-based sampling can also lead to leaving dense clusters of camera poses. For example, cluster 404 includes many of camera poses 302.

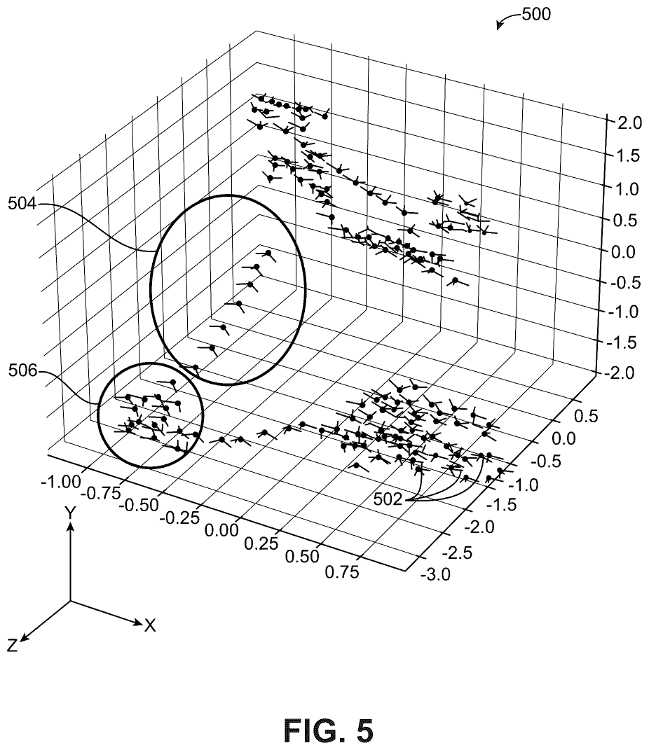

FIG. 5 includes a 3D graph 500 including camera poses 502, sampled according to various aspects of the present disclosure. Camera poses 502 may be a sampled set of camera poses 202.

Camera poses 502 may be sampled from among camera poses 202 based on a farthest-point-sampling FPS algorithm. The FPS algorithm may sparsely sample the clusters (e.g., cluster 506) while retaining sufficient frames from the fast-motion trajectories (e.g., poses of sparse region 504). The FPS algorithm may iteratively select a camera pose from among camera poses 202 that is farthest (e.g., spatially, for example, in the 3D space) from the previously selected camera poses of camera poses 502. For example, the FPS algorithm may select a first camera pose of camera poses 202. Next, the FPS algorithm may select a camera pose farthest from the first camera pose from among camera poses 202 as the second camera pose of camera poses 502. Next, the FPS algorithm may select a camera pose farthest from the first camera pose and the second camera pose from among camera poses 202 as the third camera pose of camera poses 502. The “distance” between points (e.g., to determine which point is “farthest”) may be based on a L2 distance.

Sampling camera poses 202 according to an FPS algorithm may sparsely sample clusters while retaining sufficient frames from the fast-motion trajectories. However, the camera poses comprise a position (e.g., x, y, and z coordinates) and an orientation (e.g., a roll, pitch, and yaw). According to various aspects of the present disclosure, the FPS algorithm is not directly applied to position and orientation together as the units of the position components are different from the orientation components. Applying the FPS algorithm to both position and orientation components would lead to a bias towards one or the other.

Instead, the systems and techniques project a fixed virtual point in front of the camera and concatenate the 3-dimentional camera origin with the 3-dimentional virtual point.

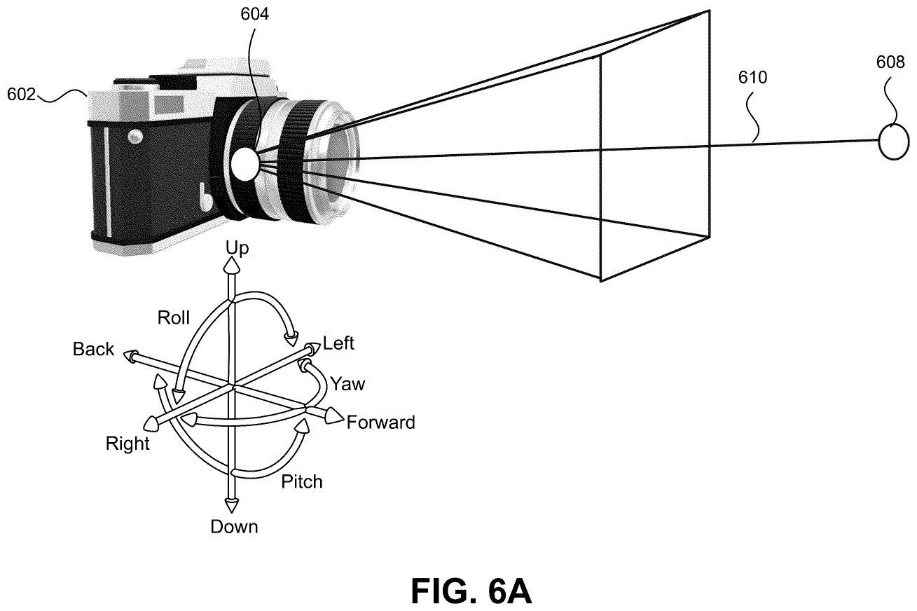

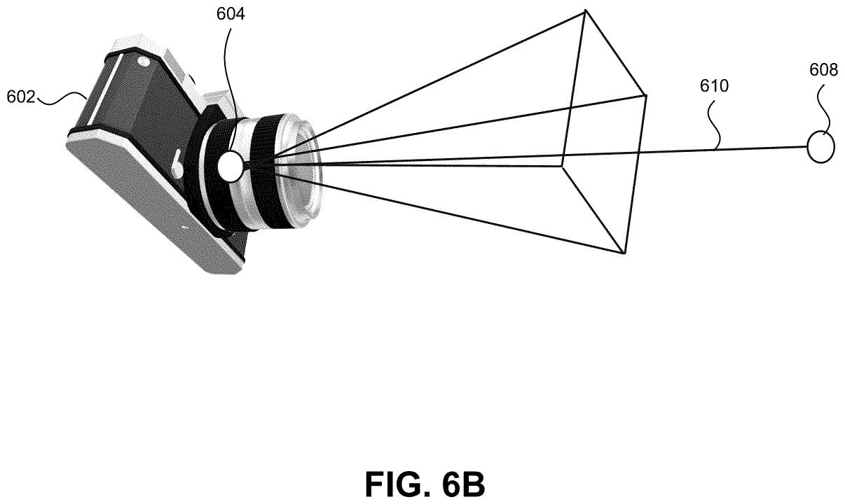

For example, FIG. 6A includes an illustration of a camera 602 and a 3D point 608 projected in front of camera 602, according to various aspects of the present disclosure. The systems and techniques may concatenate a position of center point 604 and a position of 3D point 608 (e.g., 3D coordinates of each of center point 604 and 3D point 608) and perform an FPS algorithm selection of poses based on the concatenated positions of center point 604 and 3D point 608. In a 6-dimensional vector (e.g., the x, y, and z coordinates of center point 604 and the x, y, and z coordinates of 3D point 608) all the components are of the same unit.

Additionally, the resulting representation of a line segment (e.g., line segment 610) naturally filters poses with similar 3D position and viewing direction but different roll-rotation. Images captured from the same camera poses, the only difference being a roll angle, do not provide enough new information to a model-based scene optimization. Such images may be dropped without degrading the quality of the resulting model. For example, camera 602 captures a first image from the orientation illustrated in FIG. 6A and camera 602 captures a second image from the orientation illustrated in FIG. 6B (e.g., with the same center point 604 and the same 3D point 608), the first image and the second image may be substantially redundant when used for training a model.

In some aspects, semantic information can be used to guide frame selection. For example, semantic information may be used to avoid training a model using images including mirrors as reflections are notoriously hard to learn as a surface.

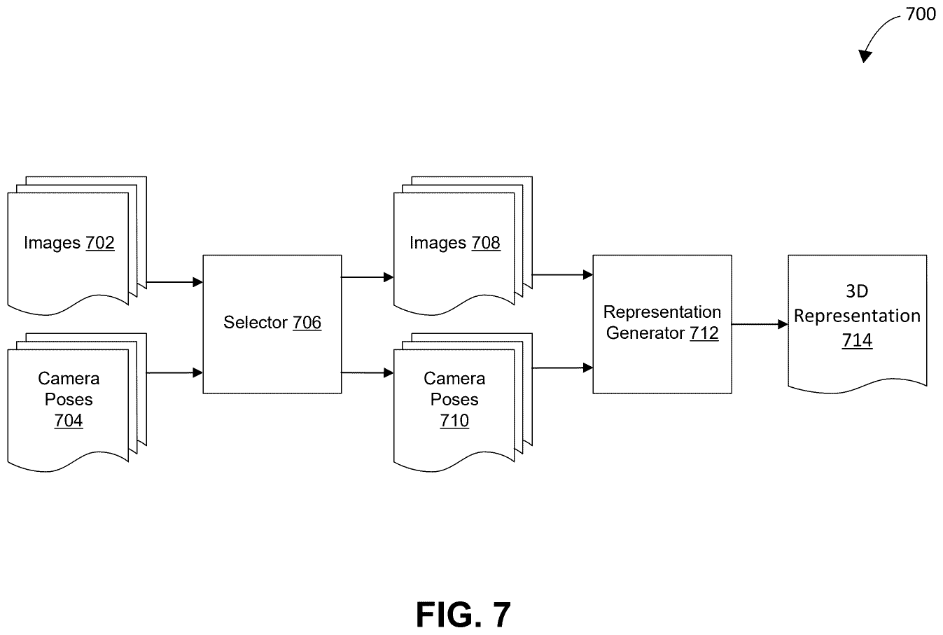

FIG. 7 is a block diagram of an example system 700 for generating a 3D representation 714 based on images 702, according to various aspects of the present disclosure. Images 702 may be, or may include, images of objects, scenes, and/or people. Images 702 may be captured from a variety of perspectives relative to the objects, scenes, and/or people.

Camera poses 704 may be poses (e.g., positions and orientations) from which images 702 were captured). Camera poses 202 of FIG. 2 may be examples of camera poses 704.

Selector 706 may select a subset of images 702 based on camera poses 704. For example, selector 706 may determine a 3D point for each of camera poses 704. For example, center point 604 of FIG. 6A may be a position of each of camera poses 704. Selector 706 may determine a 3D point 608 for each position of camera poses 704.

Selector 706 may combine (e.g., concatenate) the positions of the camera center points (e.g., the positions of camera poses 704, such as center point 604) with the determined 3D points (e.g., 3D points 608). For example, selector 706 may form a vector with 6 positional elements, (an x coordinate for the camera center point, a y coordinate for the camera center point, and a z coordinate for the camera center point, an x coordinate for the determined 3D point, a y coordinate for the determined 3D point, and a z coordinate for the determined 3D point).

Selector 706 may perform an FPS selection to select camera poses 710 from among camera poses 704. For example, selector 706 may iteratively select a camera pose from among camera poses 704 that is farthest from the previously-selected camera poses. Selector 706 may select images 708 corresponding to each of camera poses 710.

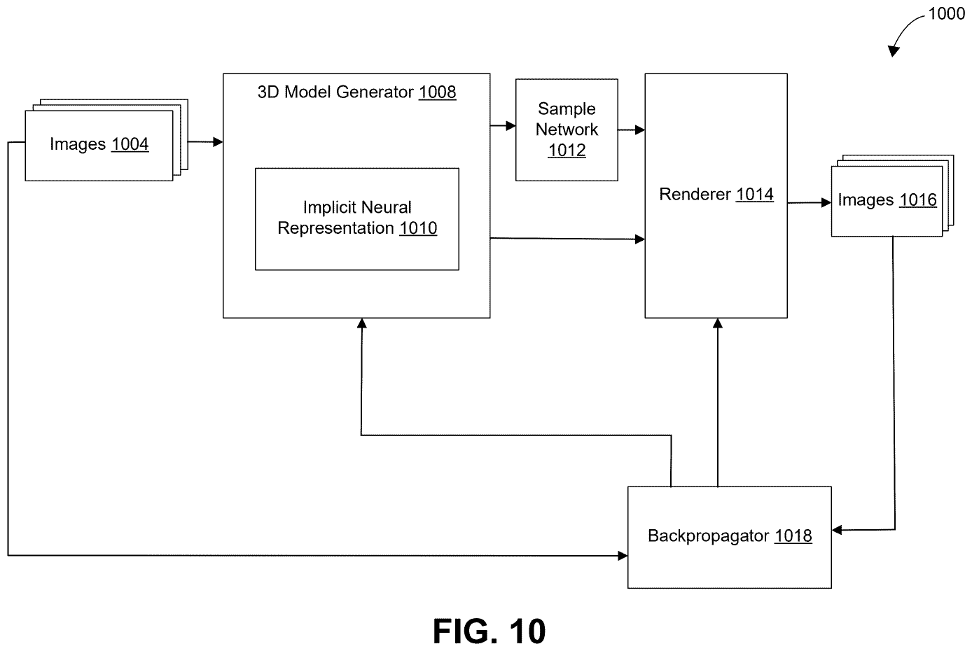

Representation generator 712 may generate 3D representation 714 based on images 708 and camera poses 710. For example, system 100 may be an example of representation generator 712. Additionally or alternatively, representation generator 712 may generate 3D representation 714 based on principles described with regard to FIG. 10 through FIG. 13.

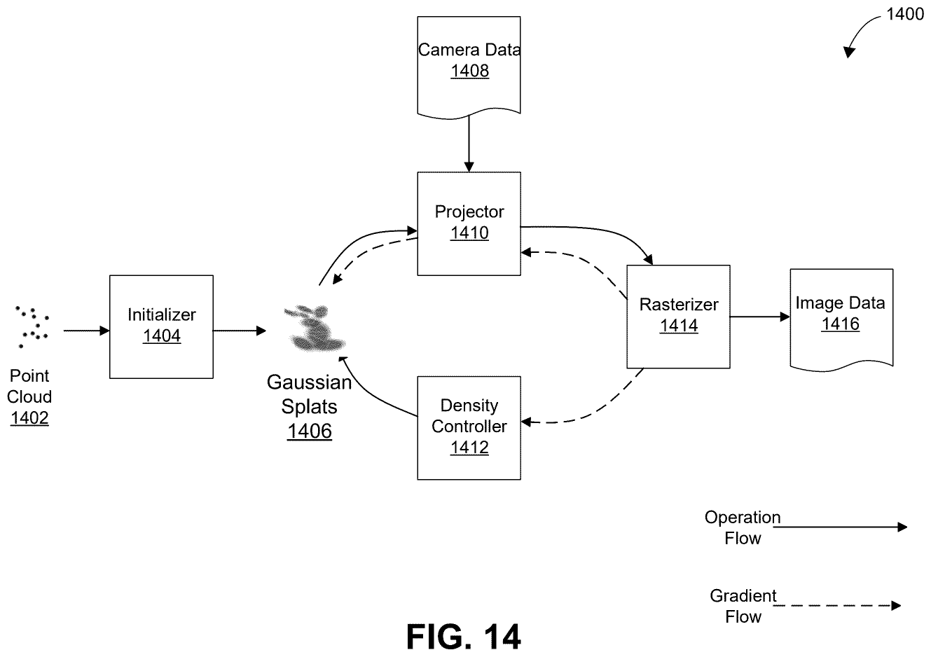

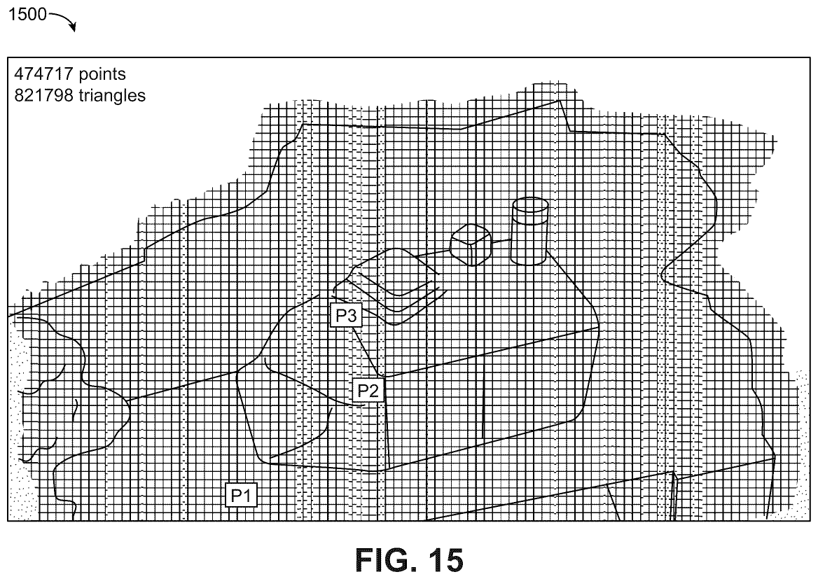

Additionally or alternatively, representation generator 712 may generate 3D representation 714 according to a Gaussian-splatting technique (e.g., as described with regard to FIG. 14) or a TSDF-volume generation technique (e.g., as described with regard to FIG. 15 through FIG. 19).

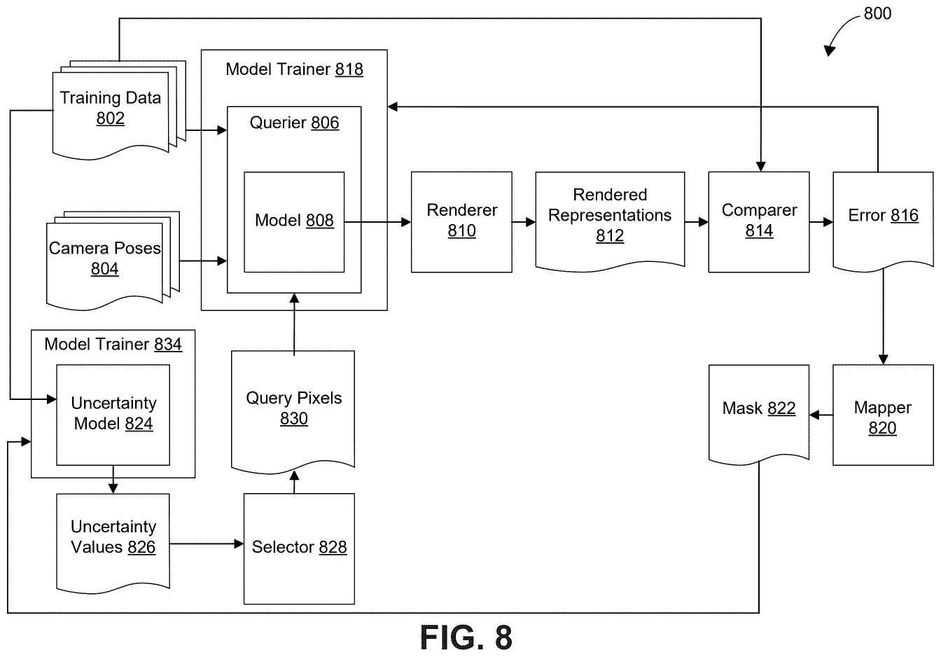

FIG. 8 is a block diagram illustrating an example system 800 for generating 3D representations and/or 2D representations, according to various aspects of the present disclosure. System 800 may iteratively generate model 808 to be an implicit neural representation of objects, scenes, and/or people based on training data 802 of the objects, scenes, and/or people.

Training data 802 may include images that may be the same as, or may be substantially similar to, training data 102 of FIG. 1A. For example, training data 802 may include images, depth data, and/or normals. Camera poses 804 may be the same as, or may be substantially similar to, camera poses 112 of FIG. 1A.

Model 808 may be an implicit neural representation of the objects, scenes, and/or people depicted in training data 802. For example, model 808 may be a NeRF, an SDF, a MonoSDF, or a Occ-SDF. Model 808 may be the same as, or may be substantially similar to, model 116 of FIG. 1A. System 800 may iteratively generate or train model 808 to implicitly represent the objects, scenes, and/or people depicted by the images of training data 802.

Querier 806 may project rays from query pixels 830 (which include pixel positions related to training data 802) through a 3D space and query model 808 regarding points along the projected rays. Renderer 810 may render a 3D representation of the objects, scenes, and/or people based on the responses of model 808 to the queries of querier 806. Additionally or alternatively, renderer 810 may render rendered representations 812 based on based on the 3D representation and/or based on responses of model 808 to the queries of querier 806. Rendered representations 812 may be, or may include, 2D representations, such as images. Additionally or alternatively, rendered representations 812 may include 2D representations of depth and/or normals. Renderer 810 may be the same as, may be substantially similar to, and/or may perform the same, or substantially the same, operations as renderer 118 of FIG. 1A.

Comparer 814 may compare rendered representations 812 to training data 802 and generate error 816 based on the comparison. Error 816 may be based on differences between training data 802 and rendered representations 812. Comparer 814 may be the same as, may be substantially similar to, and/or may perform the same, or substantially the same, operations as comparer 134 of FIG. 1A. Error 816 may be the same as, or may be substantially similar to, error 136 of FIG. 1A.

Model trainer 818 may modify parameters (e.g., weights) of model 808 based on error 816 to decrease error 816 in future iterations of the iterative process of training model 808 to represent the objects, scenes, and/or people.

Uncertainty model 824 may generate uncertainty values 826 based on training data 802. Uncertainty model 824 may be trained to generate uncertainty values 826 such that uncertainty values 826 indicate pixels of training data 802 associated with uncertainty (e.g., uncertainty related to depth and/or normals of points represented by the pixels). For example, uncertainty model 824 may be trained based on error 816 which may be determined based, at least in part, on uncertainty or error between depth and/or normals of training data 802 and rendered representations 812.

For example, mapper 820 may generate mask 822 based on error 816. Mapper 820 may map error 816 to pixel coordinates of images (e.g., of training data 802). Mask 822 may be based on such a mapping.

Model trainer 834 may train uncertainty model 824 based on mask 822 (e.g., based on errors in relation to pixel positions of images). Model trainer 834 may iteratively train uncertainty model 824 to predict depth and/or normal uncertainties based on training data 802. Model trainer 834 may iteratively train uncertainty model 824 as model trainer 818 iteratively trains model 808.

Uncertainty model 824 may generate uncertainty values 826 based on training data 802. Uncertainty values 826 may be, or may include, an uncertainty value for each pixel of each image of training data 802.

Selector 828 may select pixels of images of training data 802 as query pixels 830 based on uncertainty values 826. For example, selector 828 may select a predefined number (which may be a hyperparameter) of pixels (e.g., the predefined number with the highest uncertainty).

In contrast, system 800 generates uncertainty values 826 (and query pixels 830) using uncertainty model 824. System 800 causes uncertainty model 824 to become more and more precise as the training of model 808 and uncertainty model 824 progresses.

System 800 balances the optimization time vs bias-reduction, as system 800 predicts the uncertainty map at every step of the iterative training process. Additionally, in the later stages of the training, this prediction is very accurate and almost equivalent to doing the exact estimation from DebSDF, but without any bias as a side effect.

In conventional implicit-neural-representation generation, to learn a sequence, models (e.g., NeRF models) sample images at random pixel locations. However, learning a 3D structure is not uniformly difficult task, as some areas are easy (e.g., planar walls, ceiling, and/or floor) and other are hard (tiny structures, curved objects, etc.).

Error-driven ray sampling improves on conventional implicit-neural-representation generation, by selecting rays based on uncertainty. For example, depth and normal uncertainty is modelled then fused (e.g., to generate combined uncertainty). For example, the top row of 2D representations 904 include 2D visual representations of uncertainty. The combined uncertainty is thresholded to create a mask of error-prone regions. The mask may be used to guide the ray sampling (e.g., by selecting the N pixels with highest error).

The issue with this approach is that the normal and depth uncertainties have to be rendered for every pixel first, which is computationally expensive. Instead, the systems and techniques employ a convolutional network (e.g., uncertainty model 824), trained to regress densely the combined uncertainty trained with the sparse supervision of the already sampled rays to compute the loss and their corresponding uncertainty. The forward pass of this network is many times faster than the dense volumetric rendering needed otherwise, at the cost of being approximative to the underlying uncertainty.

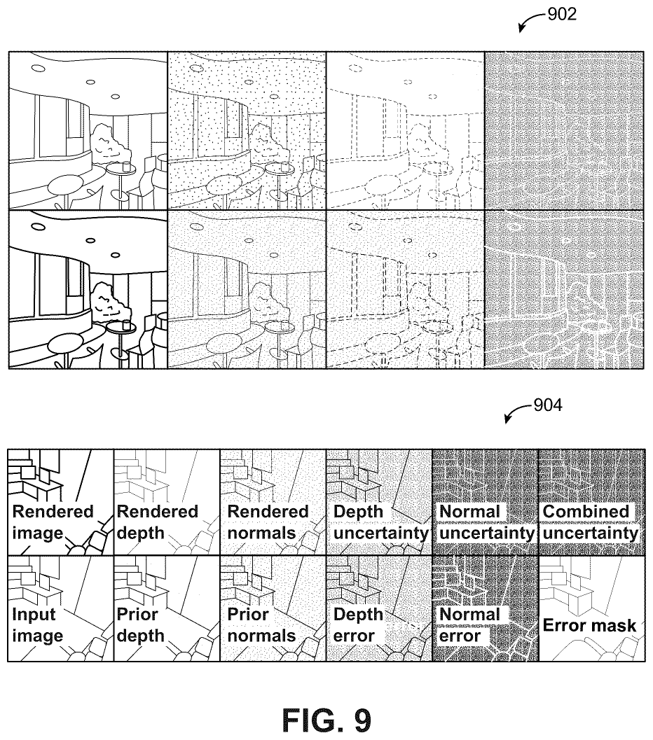

FIG. 9 includes example 2D representations 902, according to various aspects of the present disclosure. 2D representations 902 include example 2D visual representations rendered from outputs of an early stage of a NeRF optimization where normal and depth errors are still high. Uncertainty model 824 may be trained to focuses training of model 808 on thin structures and objects rather than the flat ceiling and wall panels.

2D representations 904 include example 2D visual representations computed from a DebSDF NeRF model. In DebSDF Neft, the dense normal and depth uncertainty have to be estimated frequently for every pixel which is computationally expensive. Caching mechanisms or less-frequent updates incur bias in the resulting error mask.

FIG. 10 is a block diagram illustrating a system 1000 for generating an implicit neural representation 1010 of an object, scene, person etc. (e.g., a Neural Radiance Field (NeRF)). System 1000 may use images 1004 as inputs, and as ground truth, in training implicit neural representation 1010 and renderer 1014 through a backpropagation training process.

Images 1004 may be, or may include, images of one or more objects, scenes, persons, etc. Image 1004 may include images captured from multiple viewing angles.

System 1000 may train, through a backpropagation training process, three-dimensional model generator 1008 based on images 1004 to generate an implicit neural representation (within the weights of implicit neural representation 1010) of an object represented in image 1004.

System 1000 may provide images 1004 to three-dimensional model generator 1008, and three-dimensional model generator 1008 may generate implicit neural representation 1010 of the objects, scenes, persons, etc. represented by images 1004. Implicit neural representation 1010 may be, or may include, weights between nodes of layers of a neural network (e.g., a multi-view reconstruction network). Implicit neural representation 1010 may implicitly represent geometry of the objects, scenes, persons etc.

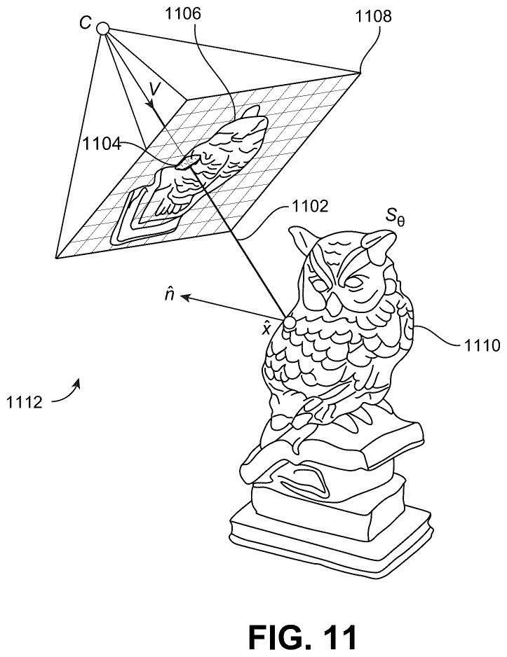

Implicit neural representation 1010 may be configured to receive a viewing ray (which may be defined by “c+t₀v,” where “c” is the camera position, “v” is a vector defining a direction between “c” and a pixel location “p”, “t” is a scale variable that, at least in part, defines the length of the vector v, and “t₀” is a scale initialization). Additionally, implicit neural representation 1010 may provide occupancy values (color values, opacity values, and/or TSDF values) along the ray. Implicit neural representation 1010 may generate a surface function “f” and occupancy values for a given viewing ray may be given by “f(c+t₀v)”. Implicit neural representation 1010 may be configured to receive a viewing ray and to provide information regarding whether the object occupies a number of points along the ray. FIG. 11 illustrates a simulated ray 1102 projected through pixel 1104 of an image 1106 of a simulated image plane 1108 into a simulated three-dimensional volume 1112. Implicit neural representation 1010 may receive a viewing ray c+t₀v and may return values indicative of points along the viewing ray that are occupied by object 1110.

Returning to FIG. 10, outputs from implicit neural representation 1010 (including f(c+t₀v)) may be provided to sample network 1012. \hat{x} represents intersection of the viewing ray c+tv with the implicit surface. \hat{n} represents the normal of the surface at a given \hat{x}. Sample network 1012 may represent \hat{x} and \hat{n} as differentiable functions of the implicit geometry and camera parameters. For example,

$$\hat{x} = c + {t}_{0} v - \frac{v}{∇ {f}_{0} \cdot {v}_{0}} f ( c + {t}_{0} v ) ; and \hat{n} = ∇ f ( \hat{x} ) .$$

Sample network 1012 may receive, f(c+t₀v) from implicit neural representation 1010. Additionally, sample network 1012 may receive c and v corresponding to the viewing ray (e.g., from system 1000). Sample network 1012 may determine \hat{x} and \hat{n} for the c and v.

Implicit neural representation 1010 may provide a feature vector \hat{z} to renderer 1014. Sample network 1012 may provide \hat{x} and \hat{n} to renderer 1014. Additionally, v may be provided to renderer 1014.

Renderer 1014 may be, or may include, a multilayer perceptron that may be trained, through the backpropagation process, to render images 1016 based on inputs from implicit neural representation 1010 and sample network 1012. Renderer 1014 may, based on a number of sets of v, \hat{x}, \hat{n}, and \hat{z}, render an image 1016 of the object, as represented by implicit neural representation 1010, from a camera position c and a viewing direction v. Image 1016 may be, or may include, an image of the objects, scenes, people, etc.

While training implicit neural representation 1010 through the backpropagation process, system 1000 may be given camera positions and viewing angles corresponding to images 1004. Backpropagator 1018 may use images 1004 as ground truth and may compare images 1016 generated by renderer 1014 to images 1004 to determine a loss, for example, according to:

$$loss = {\sum }_{r} {‖ {C}_{p} ( r ) - {C}_{g} ( r ) ‖}^{2}$$

where C is the occupancy and/or color information (e.g., with a value of 0 representing no occupancy, a value of 1 representing occupancy, etc.). Cₚ includes outputs sampled from the model and C_{g} may include ground-truth annotations. Gamma is the parameter to be optimized in training the model.

System 1000 may update weights of implicit neural representation 1010 and/or renderer 1014 based on information from backpropagator 1018 to improve, through the end-to-end backpropagation process, implicit neural representation 1010 and renderer 1014 to better render image 1016.

Once trained, renderer 1014 may be capable of generating (based on implicit neural representation 1010) new two-dimensional images of the object represented in images 1004 from camera positions and viewing angles not represented in images 1004.

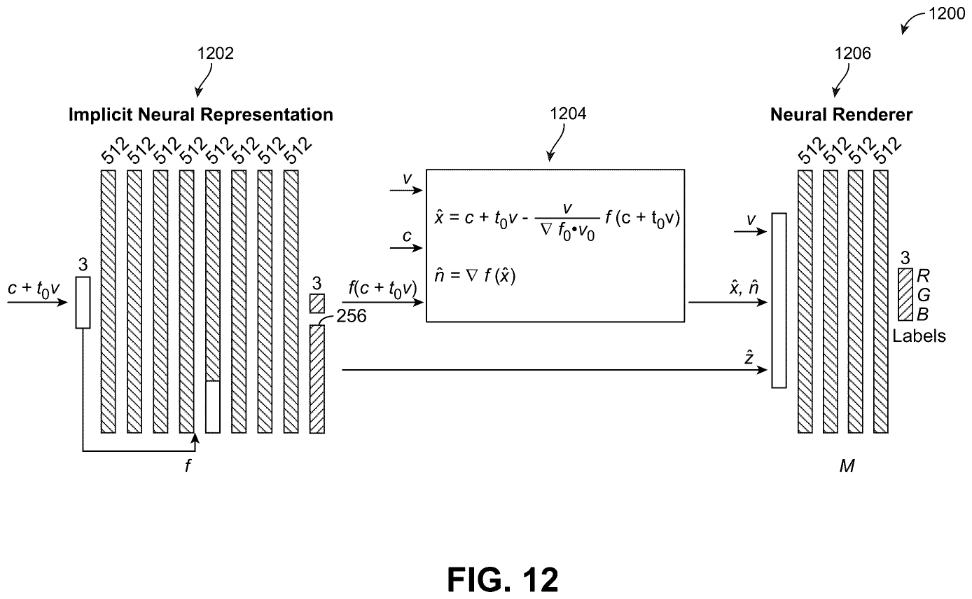

FIG. 12 is a block diagram illustrating a machine-learning model 1200 (which, once trained, may be used to generate a three-dimensional model), according to various aspects of the present disclosure. Machine-learning model 1200 includes implicit neural representation 1202 (which may be the same as, substantially similar to, or perform the same, or substantially the same, operations as implicit neural representation 1010 of FIG. 10), sample network 1204 (which may be the same as, substantially similar to, or perform the same, or substantially the same, operations as sample network 1012 of FIG. 10), and neural renderer 1206 (which may be the same as, substantially similar to, or perform the same, or substantially the same, operations as renderer 1014 of FIG. 10).

Machine-learning model 1200 may produce differentiable pixel values (e.g., red-green-blue RGB values) for learnable camera positions c and some fixed image pixel p as follows. The camera parameters and pixel are used to define a viewing direction v. \hat{x} is defined as the intersection of the viewing ray c+tv with the implicit surface.

Sample network 1204 represents \hat{x}, and the normal to the surface ñ as differentiable functions of the implicit geometry and camera parameters.

The final radiance reflected from the geometry toward the camera c in direction v, i.e., RGB, are approximated by the neural renderer 1206. Neural renderer 1206 may be a multilayer perceptron that takes as input the surface point \hat{x} and normal \hat{n}, the viewing direction v, and a global geometry feature vector z.

In turn, the model is incorporated in a loss comparing it to the ground truth pixel color that enables learning simultaneously the geometry, its appearance and camera parameters.

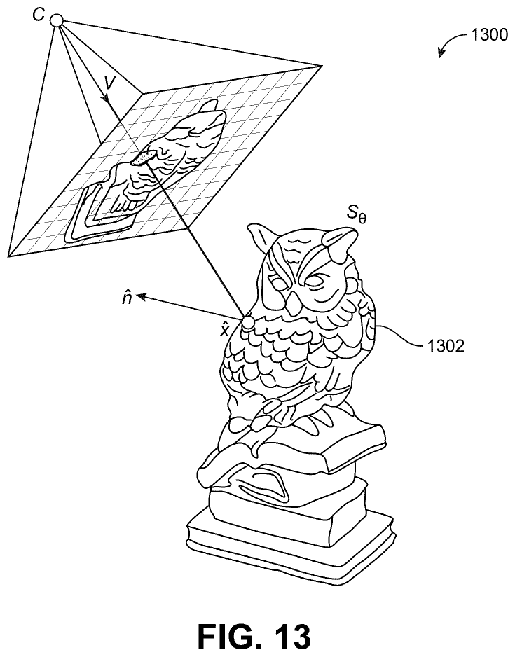

FIG. 13 is a diagram 1300 illustrates an example three-dimensional model 1302 to provide context for a description of generating the three-dimensional model 1302, according to various aspects of the present disclosure.

After a machine-learning model (e.g., three-dimensional model generator 1008 and renderer 1014, or machine-learning model 1200 of FIG. 12) is trained (e.g., through the end-to-end backpropagation process described with regard to FIG. 10 or FIG. 12), the implicit neural representations of the machine-learning model (e.g., implicit neural representation 1010 or implicit neural representation 1202) can be sampled at various points. For example, various camera locations c and various viewing angles v can be provided to the trained machine-learning model. The trained machine-learning model will provide images of the object as viewed from the locations c and the viewing angles v. The camera locations c and viewing angles v may cover the whole object and may use the occupancy network (e.g., implicit neural representation 1010 or implicit neural representation 1202) to find the surface point. The color of surface point can also be obtained in the same way using the RGB density field (e.g., of renderer 1014 of FIG. 10 or neural renderer 1206 of FIG. 12). As an example, each point of a three-dimensional space (e.g., each voxel of the three-dimensional space) may be sampled by providing corresponding camera locations c and viewing angles v to determine a point-cloud representation as model 1302. In some cases, bounding boxes may be applied to reduce the number of sampling points when sampling the three-dimensional space.

A point-cloud representation of the surface of the object may be generated by sampling the implicit neural representation of the trained machine-learning model. A Poisson reconstruction algorithm can be used to extract the mesh from the point-cloud representation.

As mentioned above, Gaussian splatting is a technique for generating a digital three-dimensional (3D) representation of a scene, object, person, etc. Gaussian splatting involves generating 3D Gaussian splats (e.g., oblate, spherical, or prolate spheroids) to represent the scene, object, person, etc. based on images of the scene, object, person, etc. through an iterative gradient-descent process.

FIG. 14 is a diagram illustrating an example system 1400 for generating Gaussian splats 1406.

In general, system 1400 may be provided with a point cloud 1402. For example, a camera may capture a number of images of a scene, object, person, etc. The number of images may be processed, for example, according to a structure from motion (SfM) technique, to generate a point-cloud representation (e.g., point cloud 1402) of the scene, object, person, etc.

An initializer 1404 may generate Gaussian splats 1406 based on point cloud 1402. For example, for each point in point cloud 1402, initializer 1404 may generate a Gaussian splat.

In the present disclosure, the term “Gaussian splat” may refer to a shape (e.g., an oblate, spherical, or prolate spheroid) that is used as part of a representation of a 3D object, person, scene, etc. In the present disclosure, the term “Gaussian splats” may refer to more than one Gaussian splat. Additionally, the term “Gaussian splats” may refer to a 3D representation made up of Gaussian splats.

System 1400 may iteratively adjust Gaussian splats 1406 to cause Gaussian splats 1406 to better and better represent the scene, object, person, etc. For example, projector 1410 may project Gaussian splats 1406 based on camera data 1408 (which may include positions from which images of the scene, object, person, etc. were captured). Additionally, rasterizer 1414 may rasterize the projected Gaussian splats into an image plane to generate image data 1416. System 1400 may compare image data 1416 with the images on which point cloud 1402 is based. Further, system 1400 (e.g., using rasterizer 1414, projector 1410, and density controller 1412) may adjust Gaussian splats 1406 according to a gradient-descent technique such that in further iterations of the iterative process, Gaussian splats 1406 better represents the scene, object, person, etc. captured in the input images.

A training strategy for gaussian splatting may (e.g., as illustrated and described with regard to FIG. 14) may include obtaining a point cloud (e.g., point cloud 1402). The point cloud may be obtained from, for example, COLMAP, which is a general-purpose Structure-from-Motion (SfM) and Multi-View Stereo (MVS) pipeline with a graphical and command-line interface. The point cloud may be a reconstruction based on multi-view images.

For gaussian initialization, training strategy may directly initialize gaussian position with the point clouds from COLMAP. Each Gaussian splat (which may alternatively be referred to as a “primitive”) may include parameters including a position (e.g., position of the Gaussian splat in a 3D space), a scale (e.g., a size of the Gaussian splat), an opacity (e.g., describing how opaque or translucent the Gaussian splat is), a rotation (e.g., orientation of the Gaussian splat), and a color (e.g., a color of the Gaussian splat). The training strategy may try to optimize the parameters of the Gaussian splats to map to the real image. The resulting Gaussian splats can be used as 3D representation.

As an illustrative example, a system can perform 3DR to reconstruct a 3D scene from 2D image frames. The system can divide the scene into 3D blocks (e.g., voxels, voxel blocks, or volume blocks). For example, the system may project each voxel block onto a 2D depth frame and a 2D image to determine the depth and/or color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color. In the present disclosure, the term “3DR,” “3D reconstruction understanding,” and “3DRU,” may refer to 3D reconstruction algorithms, techniques, systems, modules, etc.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of “1” or “0”), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to “1.”

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, depth integration, and surface extraction. During block selection, blocks that have surfaces or are located close to a surface can be selected. These blocks can then be allocated into memory. In depth integration (also referred to as block integration), all voxel blocks within a block volume can be iterated over and an updated TSDF value weight can be calculated. In surface extraction, marching cubes can be used to determine triangular surfaces in the blocks.

In block selection, depth pixels can be iterated over to unproject them to a 3D space and determine where they lie within the 3D space using intrinsic and extrinsic camera parameters. Typically, a hash map is employed for block selection. A hash map is an unordered map that includes a listing of blocks (e.g., including block indices of the blocks) that have a surface. The hash map can include a corresponding counter for each of the blocks that maintains a count of the number of times depth pixels lie within the particular block. A threshold (e.g., threshold value or number) can be used to select all the blocks that have depth pixels lie within them for more than the threshold number of times. The selected blocks can then be integrated. The cache size (e.g., size of the hardware for the cache memory, which can be used to store the hash map) can depend upon the depth range, sample distances, block size, etc.

A system may generate a three-dimensional (3D) map of an environment of the system based on images of the environment. For example, volume blocks (e.g., “voxels” or “voxel blocks”) are often used to reconstruct a 3D scene from 2D images (e.g., stereoscopically-paired images obtained from a stereoscopic pair of cameras). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

A 3D reconstruction technique (“3DR”) utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four-centimeter block dimension. In some examples, for this room, the occupied voxel blocks may only be about ten to fifteen percent.

FIG. 15 is a diagram illustrating an example of a scene that has been modeled as a 3D sparse volumetric representation for 3DR. In particular, FIG. 15 is a diagram illustrating an example of a 3D surface reconstruction 1500 of a scene modeled with an overlay of a volume grid containing voxel blocks. For 3DR, a camera (e.g., a stereo camera) may take photos of the scene from various different viewpoints and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and, in some cases, can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

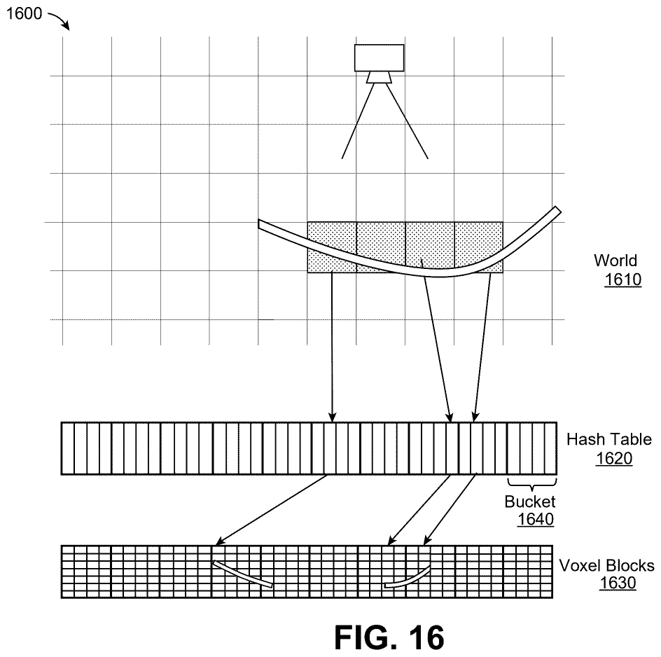

FIG. 16 is a diagram illustrating an example of a hash map lookup type of volume block representation. In particular, FIG. 16 is a diagram illustrating an example of a hash-mapping function 1600 for indexing voxel blocks 1630 in a volume grid. In FIG. 16, a volume grid is shown with world coordinates 1610. Also shown in FIG. 16 are a hash table 1620 and voxel blocks 1630. In one or more examples, a hash function can be used to map the integer world coordinates 1610 into hash buckets 1640 within the hash table 1620. The hash buckets 1640 can each store a small array of points to regular grid voxel blocks 1630. Each voxel block 1630 contains data that can be used for depth integration.

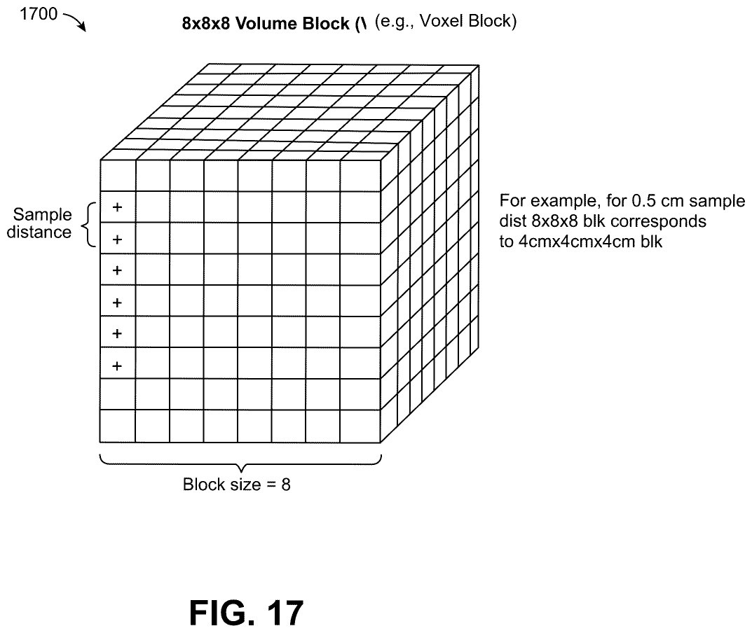

FIG. 17 is a diagram illustrating an example of a volume block (e.g., a voxel block) 1700. In FIG. 17, the voxel block 1700 is shown to have a block size of eight. For example, a 0.5-centimeter (cm) sample distance for an eight by eight-by-eight voxel block can correspond to a four cm by four cm by four cm voxel block. That is, the voxel block 1700 includes a 3D lattice of 512 voxels, the voxels arranged so that the voxel block 1700 has a width of 8 voxels, a length of 8 voxels, and a height of 8 voxels. In one or more examples, each voxel block (e.g., voxel block 1700) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on:

$$tsdf = \{ \begin{matrix}- 1 , & if d \leq - ramp \\ \frac{d}{ramp} , & if - ramp < d < ramp \\ 1 , & if d \geq ramp\end{matrix} \}$$

$$sample . tsdf = ( \frac{sample . weight * sample . tsdf + tsdf}{sample . weight + 1} )$$

A TSDF integration or fusion process can be employed that updates the TSDF values and weights with each new observation from the sensor (e.g., camera).

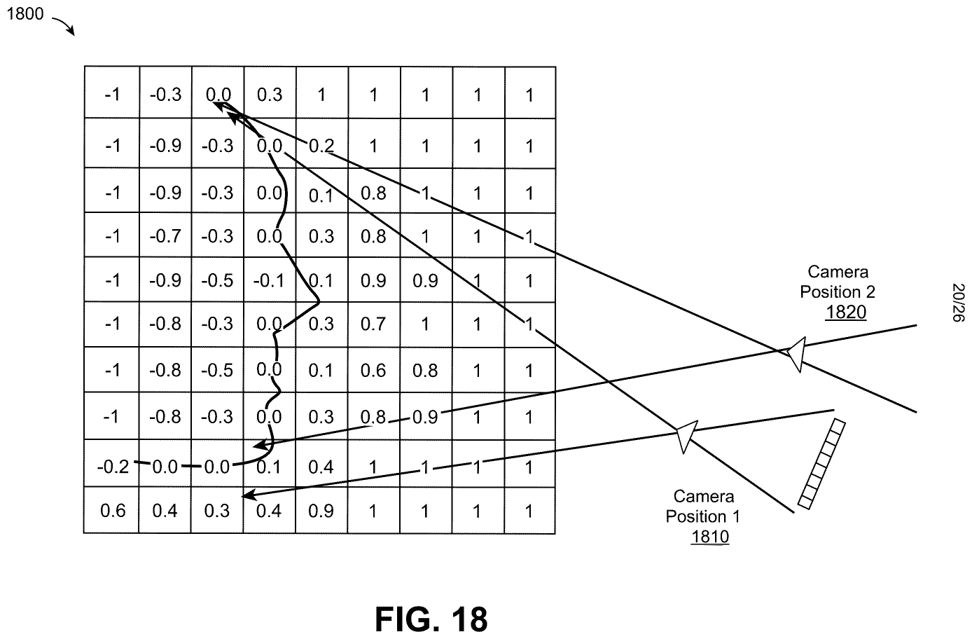

FIG. 18 is a diagram illustrating an example of a TSDF volume reconstruction 1800. In FIG. 18, a voxel grid including a plurality of voxel blocks is shown. A camera is shown to be obtaining images of a scene (e.g., person's face) from two different camera positions (e.g., camera position 1810 and camera position 1820). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 18, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. Typically, each voxel block carries implicit surface information (e.g., in the form of a TSDF value and a weight for depth integration). The TSDF value is a measure of distance of the voxel block from a surface. The weight is a measure of the reliability of the TSDF value. In some cases, a TSDF weight may be estimated using various approaches, such as a simple counter (e.g., a binary weight, such as “1” or “0”), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to “1.”

A 3DR system can utilize a sequence of depth maps of a scene with their corresponding 6 DoF poses as an input. The depth maps may be generated using deep learning (DL), non-DL, and/or other depth estimation algorithms or methods. A 3D space of the scene may be uniformly sampled along the X, Y, and Z directions. The 3D space may be divided into fixed size volumes (e.g., block volumes with a fixed number of samples).

A 3DR system generally consists of three stages, which include block selection, integration, and surface extraction. During block selection, all of the blocks that have surfaces or are located close to a surface may be selected. These blocks may then be allocated into memory. In block integration, all voxel blocks within a block volume may be iterated over and an updated TSDF value weight can be calculated. In surface extraction, marching cubes may be used to determine triangular surfaces in the blocks.

In block selection, depth pixels may be iterated over to unproject them to a 3D space and determine where they lie within the 3D space using intrinsic and extrinsic camera parameters. Usually, a hash map is employed for block selection. A hash map is an unordered map, which includes a listing of blocks (e.g., including block indices of the blocks) that have a surface. The hash map may include a corresponding counter for each of the blocks that maintains a count of the number of times depth pixels lie within the particular block. A threshold (e.g., threshold value or number) may be used to select all the blocks that have depth pixels lie within them for more than the threshold number of times. The selected blocks may then be integrated.

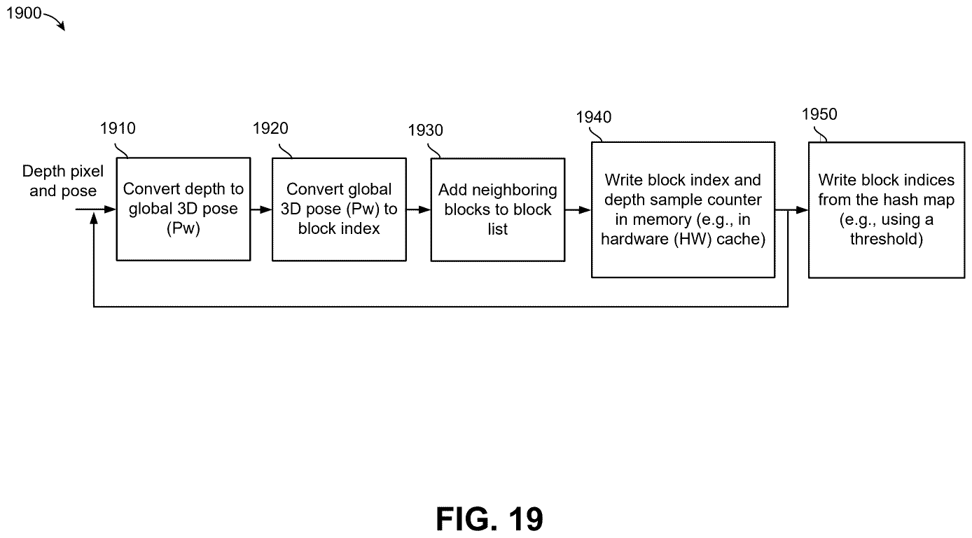

FIG. 19 is a diagram of an example voxel block selection algorithm for 3DR of a scene. In particular, FIG. 19 is a diagram illustrating an example of a voxel-block-selection algorithm 1900. In FIG. 19, for operation of the voxel-block-selection algorithm 1900, a plurality of depth pixels associated with a plurality of depth maps of the scene can be obtained by one or more processors. In one or more examples, each depth map of the plurality of depth maps is associated with a respective pose (e.g., 6 DoF pose) of an image sensor. In some examples, each depth pixel of the plurality of depth pixels is associated with a depth value. The one or more processors can iterate the voxel-block-selection algorithm 1900 over every depth value in the depth maps.

During operation of the voxel-block-selection algorithm 1900, at operation 1910, the one or more processors can convert the depth values of the plurality of depth pixels to a plurality of global three-dimensional (3D) points in a global coordinate system. In one or more examples, the converting of the depth values of the plurality of depth pixels to the plurality of global 3D points in the global coordinate system can be achieved by the one or more processors unprojecting the depth values to a 3D space. At operation 1920, the one or more processors can determine indices of blocks (e.g., voxel blocks) associated with the plurality of global 3D points. At operation 1930, the one or more processors can generate a listing of blocks including the indices of the blocks associated with the plurality of global 3D points and indices of neighboring blocks adjacent (e.g., next to or close) to the blocks associated with the plurality of global 3D points.

The one or more processors can then select the plurality of blocks of the scene from the listing of blocks based on a number of depth pixels of the plurality of depth pixels being located within the plurality of blocks. For example, at operation 1940, the one or more processors can increment a counter for each block in the listing of blocks each time a depth pixel of the plurality of depth pixels is located within each block. The one or more processors can write the indices and the corresponding counter values of the blocks in the listing of the blocks in memory (e.g., a hardware cache).

At operation 1950, the one or more processors can determine blocks in the listing of blocks with a counter value greater than a threshold value (e.g., a threshold number). The one or more processors can then select the plurality of blocks of the scene based on the blocks in the listing of blocks with the counter value greater than the threshold value. The one or more processors can write the indices of the selected plurality of blocks of the scene in memory (e.g., the hardware cache).

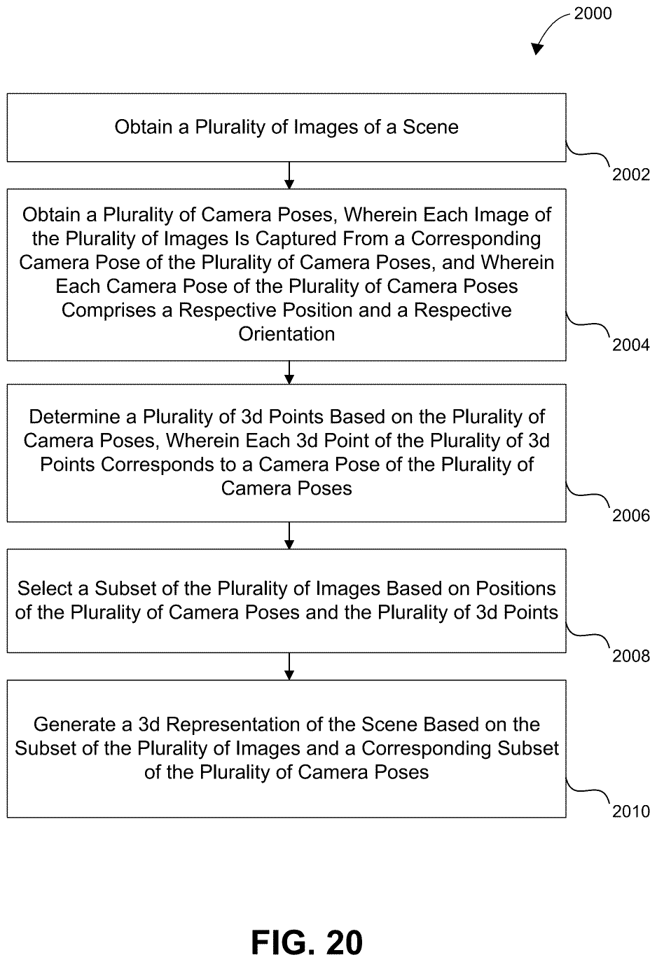

FIG. 20 is a flow diagram illustrating an example process 2000 for generating a 3D representation, in accordance with aspects of the present disclosure. One or more operations of process 2000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 2000. The one or more operations of process 2000 may be implemented as software components that are executed and run on one or more processors. System 700 of FIG. 7 may perform process 2000.

At block 2002, a computing device (or one or more components thereof) may obtain a plurality of images of a scene. For example, system 700 may obtain images 702.

At block 2004, the computing device (or one or more components thereof) may obtain a plurality of camera poses, wherein each image of the plurality of images is captured from a corresponding camera pose of the plurality of camera poses, and wherein each camera pose of the plurality of camera poses comprises a respective position and a respective orientation. For example, system 700 may obtain camera poses 704. Each of images 702 may have been captured from a respective pose (e.g., position and orientation) of camera poses 704.

At block 2006, the computing device (or one or more components thereof) may determine a plurality of 3D points based on the plurality of camera poses, wherein each 3D point of the plurality of 3D points corresponds to a camera pose of the plurality of camera poses. For example, selector 706 may determine a 3D point (e.g., 3D point 608) for each of camera poses 704.

In some aspects, to determine a 3D point of the plurality of 3D points, the computing device (or one or more components thereof) may project a ray a predetermined distance from a camera pose of the plurality of camera poses to determine the 3D point. For example, selector 706 may project a line segment 610 a predetermined length from center point 604 (e.g., an example camera pose of camera poses 704) to determine d point 608.

In some aspects, to determine a 3D point of the plurality of 3D points, the computing device (or one or more components thereof) may project a ray a predetermined distance from a position of a camera pose of the plurality of camera poses in a direction based on the orientation of the camera pose of the plurality of camera poses to determine the 3D point. For example, selector 706 may project a line segment 610 a predetermined distance from center point 604 (e.g., an example camera pose of camera poses 704) in a direction based on the orientation of the camera pose to determine 3D point 608.

In some aspects, to select the subset of the plurality of images, the computing device (or one or more components thereof) may: combine each 3D point of the plurality of 3D points with a corresponding position of a corresponding camera pose of the plurality of camera poses to generate a plurality of point-and-position pairs; apply a farthest-point-sampling technique to the plurality of point-and-position pairs to select a predetermined number of point-and-position pairs; and identify the subset of the plurality of images based on the predetermined number of point-and-position pairs. For example, selector 706 may combine (e.g., concatenate) each of the 3D points (e.g., instances of 3D point 608) determined at block 2006 with a corresponding position of a corresponding camera pose (e.g., of camera poses 704) to generate point-and-position pairs. Additionally, selector 706 may apply a farthest-point-sampling (FPS) technique to the point-and-position pairs to select a predetermined number of point-and-position pairs (e.g., as describe with regard to FIG. 5). Further, selector 706 may determine images 708 based on the predetermined number of point-and-position pairs.

In some aspects, to select the subset of the plurality of images, the computing device (or one or more components thereof) may combine each 3D point of the plurality of 3D points with a corresponding position of a corresponding camera pose of the plurality of camera poses to generate a plurality of point-and-position pairs; iteratively identify a point-and-position pair from among the plurality of point-and-position pairs that is farthest from previously-selected point-and-position pairs; and identify the subset of the plurality of images based on the identified point-and-position pairs.

For example, selector 706 may combine (e.g., concatenate) each of the 3D points (e.g., instances of 3D point 608) determined at block 2006 with a corresponding position of a corresponding camera pose (e.g., of camera poses 704) to generate point-and-position pairs. Additionally, selector 706 may iteratively identify a point-and-position pair from among the point-and-position pairs determined at block 2006 that is farthest from previously-selected point-and-position pairs (e.g., as describe with regard to FIG. 5). Further, selector 706 may determine images 708 based on the predetermined number of point-and-position pairs.

At block 2008, the computing device (or one or more components thereof) may select a subset of the plurality of images based on positions of the plurality of camera poses and the plurality of 3D points. For example, selector 706 may determine images 708 based on the positions of camera poses 704 and the 3D points determined at block 2006.

At block 2010, the computing device (or one or more components thereof) may generate a 3D representation of the scene based on the subset of the plurality of images and a corresponding subset of the plurality of camera poses. For example, representation generator 712 may determine 3D representation 714 based on images 708 and camera poses 710. Each of images 708 may be captured from a respective pose of camera poses 710.

In some aspects, to generate the 3D representation of the scene, the computing device (or one or more components thereof) may: train a neural radiance field (NeRF) to represent the scene based on the subset of the plurality of images and the plurality of camera poses; and generate a 3D mesh based on the NeRF. For example, representation generator 712 may generate a NeRF (e.g., as described with regard to FIGS. 10 through 13). Further, representation generator 712 may generate 3D representation 714 based on the NeRF.

In some aspects, to generate the 3D representation of the scene, the computing device (or one or more components thereof) may generate a plurality of Gaussian splats to represent the scene based on the subset of the plurality of images and the plurality of camera poses. For example, representation generator 712 may generate a Gaussian-splat representation of the scene (e.g., as described with regard to FIG. 14).

In some aspects, to generate the 3D representation of the scene, the computing device (or one or more components thereof) may use a truncated signed distance function (TSDF) volume to generate the 3D representation of the scene based on the subset of the plurality of images and the plurality of camera poses. For example, representation generator 712 may generate a TSDF representation of the scene (e.g., as described with regard to FIGS. 15 through 19).

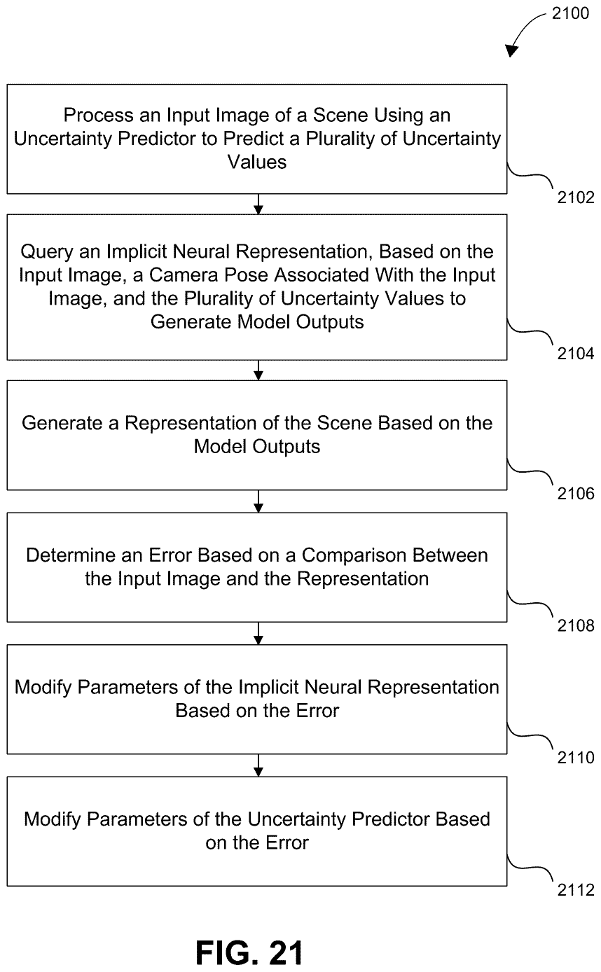

FIG. 21 is a flow diagram illustrating an example process 2100 for generating a 3D representation, in accordance with aspects of the present disclosure. One or more operations of process 2100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 2100. The one or more operations of process 2100 may be implemented as software components that are executed and run on one or more processors. System 800 of FIG. 8 may perform process 2100.

At block 2102, a computing device (or one or more components thereof) may process an input image of a scene using an uncertainty predictor to predict a plurality of uncertainty values. For example, uncertainty model 824 may process an image of training data 802 to generate uncertainty values 826.

In some aspects, the uncertainty predictor may be, or may include, a feed forward network. For example, uncertainty model 824 may be, or may include, a feed forward network.

At block 2104, the computing device (or one or more components thereof) may query an implicit neural representation, based on the input image, a camera pose associated with the input image, and the plurality of uncertainty values to generate model outputs. For example, querier 806 may query model 808 based on rays projected through query pixels 830 of the image of training data 802 based on a camera pose of camera poses 804 corresponding to the image of training data 802. Query pixels 830 may be based on uncertainty model 824.

In some aspects, the computing device (or one or more components thereof) may select a subset of the plurality of uncertainty values. The implicit neural representation may be queried based on the subset of the plurality of uncertainty values. For example, selector 828 may select query pixels 830 based on a subset of uncertainty values 826. Querier 806 may query model 808 based on query pixels 830.

In some aspects, to query the implicit neural representation, the computing device (or one or more components thereof) may: identify query pixels of the input image based on the plurality of uncertainty values; generate a ray based on the camera pose the query pixels; identify a number of 3D points along the ray; and query the implicit neural representation regarding the number of 3D points. For example, selector 828 may identify query pixels 830 of the image of training data 802 based on a subset of uncertainty values 826. Querier 806 may generate a ray from the camera pose corresponding to the image of training data 802 through each query pixel of query pixels 830 into a 3D space. Querier 806 may identify a number of 3D points long the ray. Querier 806 may query model 808 regarding the number of 3D points.

In some aspects, the implicit neural representation is trained to return, for each query point, at least one of: a color; an opacity; or a signed distance function (SDF). For example, model 808 may be trained to receive query points, and for each query point, return at least one of a color, an opacity, or an SDF.

At block 2106, the computing device (or one or more components thereof) may generate a representation of the scene based on the model outputs. For example, renderer 810 may render rendered representations 812 based on outputs of model 808.

At block 2108, the computing device (or one or more components thereof) may determine an error based on a comparison between the input image and the representation. For example, comparer 814 may determine error 816 based on a comparison between the image of training data 802 and rendered representations 812.

At block 2110, the computing device (or one or more components thereof) may modify parameters of the implicit neural representation based on the error. For example, model trainer 818 may modify parameters (e.g., weights) of model 808 based on error 816.

At block 2112, the computing device (or one or more components thereof) may modify parameters of the uncertainty predictor based on the error. For example, model trainer 834 may modify parameters (e.g., weights) of uncertainty model 824 based on error 816.

In some aspects, the computing device (or one or more components thereof) may map the error to pixel coordinates. The parameters of the uncertainty predictor may be modified based on the pixel coordinates. For example, mapper 820 may map error 816 to pixel coordinates and store the pixel coordinates as mask 822. Model trainer 834 may modify uncertainty model 824 based on mask 822.

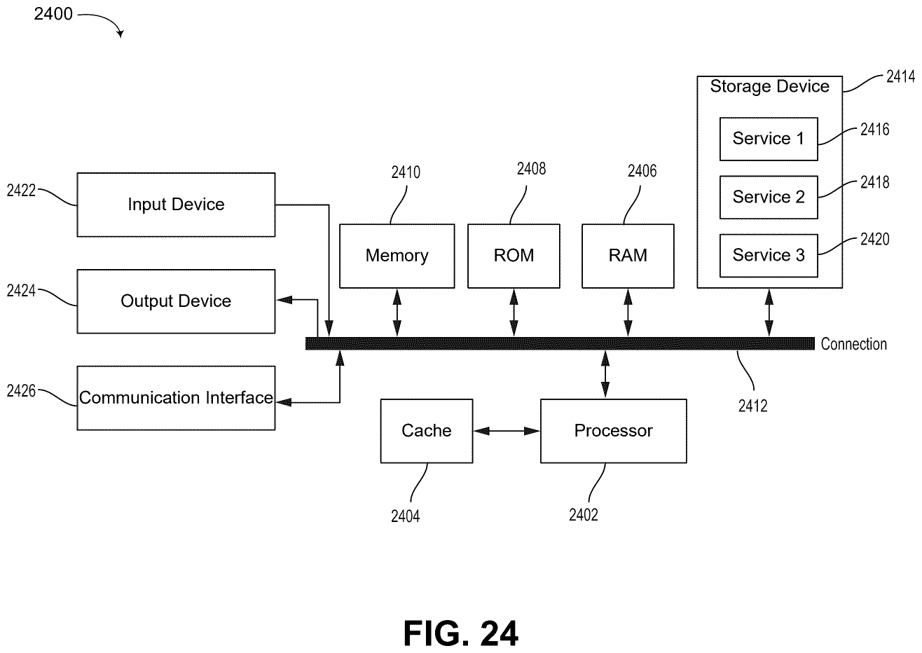

In some examples, as noted previously, the methods described herein (e.g., voxel-block-selection algorithm 1900, process 2000 of FIG. 20, process 2100 of FIG. 21, and/or other methods described herein) can be performed, in whole or in part, by a computing device or apparatus. In one example, one or more of the methods can be performed by system 700 of FIG. 7, system 800 of FIG. 8 or by another system or device. In another example, one or more of the methods (e.g., process 2000, and/or other methods described herein) can be performed, in whole or in part, by the computing-device architecture 2400 shown in FIG. 24. For instance, a computing device with the computing-device architecture 2400 shown in FIG. 24 can include, or be included in, the components of the system 700 and/or system 800 and can implement the operations of voxel-block-selection algorithm 1900, process 2000, process 2100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Voxel-block-selection algorithm 1900, process 2000, process 2100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include processes, programs, objects, components, data structures, and the like that perform particular functions or implement particular data types. The order in which the operations are described is not intended to be construed as a limitation, and any number of the described operations can be combined in any order and/or in parallel to implement the processes.

Additionally, voxel-block-selection algorithm 1900, process 2000, process 2100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

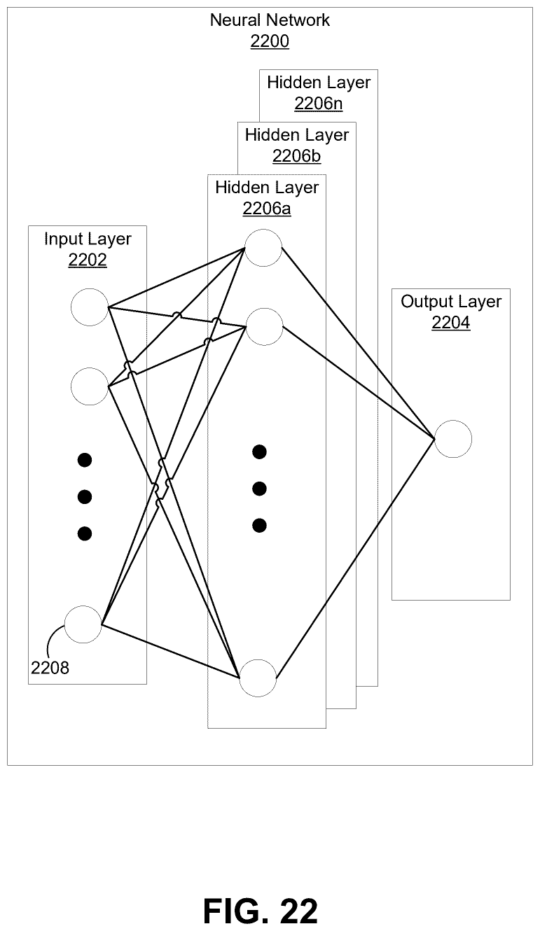

FIG. 22 is an illustrative example of a neural network 2200 (e.g., a deep-learning neural network) that can be used to implement machine-learning based implicit-neural-representation generation, uncertainty prediction, rendering, classification, object detection, image recognition (e.g., face recognition, object recognition, scene recognition, etc.), feature extraction, authentication, gaze detection, gaze prediction, and/or automation. For example, neural network 2200 may be an example of, or can implement, model 116 of FIG. 1A, model 808 of FIG. 8, uncertainty model 824 of FIG. 8, implicit neural representation 1010 of FIG. 10, implicit neural representation 1202 of FIG. 12.

An input layer 2202 includes input data. In one illustrative example, input layer 2202 can include data representing images, camera poses, and/or query pixels. Neural network 2200 includes multiple hidden layers, for example, hidden layers 2206a, 2206b, through 2206n. The hidden layers 2206a, 2206b, through hidden layer 2206n include “n” number of hidden layers, where “n” is an integer greater than or equal to one. The number of hidden layers can be made to include as many layers as needed for the given application. Neural network 2200 further includes an output layer 2204 that provides an output resulting from the processing performed by the hidden layers 2206a, 2206b, through 2206n. In one illustrative example, output layer 2204 can provide outputs (e.g., a color, opacity, and/or SDF for a given point), and/or uncertainty values.

Neural network 2200 may be, or may include, a multi-layer neural network of interconnected nodes. Each node can represent a piece of information. Information associated with the nodes is shared among the different layers and each layer retains information as information is processed. In some cases, neural network 2200 can include a feed-forward network, in which case there are no feedback connections where outputs of the network are fed back into itself. In some cases, neural network 2200 can include a recurrent neural network, which can have loops that allow information to be carried across nodes while reading in input.

Information can be exchanged between nodes through node-to-node interconnections between the various layers. Nodes of input layer 2202 can activate a set of nodes in the first hidden layer 2206a. For example, as shown, each of the input nodes of input layer 2202 is connected to each of the nodes of the first hidden layer 2206a. The nodes of first hidden layer 2206a can transform the information of each input node by applying activation functions to the input node information. The information derived from the transformation can then be passed to and can activate the nodes of the next hidden layer 2206b, which can perform their own designated functions. Example functions include convolutional, up-sampling, data transformation, and/or any other suitable functions. The output of the hidden layer 2206b can then activate nodes of the next hidden layer, and so on. The output of the last hidden layer 2206n can activate one or more nodes of the output layer 2204, at which an output is provided. In some cases, while nodes (e.g., node 2208) in neural network 2200 are shown as having multiple output lines, a node has a single output and all lines shown as being output from a node represent the same output value.

In some cases, each node or interconnection between nodes can have a weight that is a set of parameters derived from the training of neural network 2200. Once neural network 2200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 2200 to be adaptive to inputs and able to learn as more and more data is processed.

Neural network 2200 may be pre-trained to process the features from the data in the input layer 2202 using the different hidden layers 2206a, 2206b, through 2206n in order to provide the output through the output layer 2204. In an example in which neural network 2200 is used to identify features in images, neural network 2200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 2200 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 2200 is trained well enough so that the weights of the layers are accurately tuned.

For the example of identifying objects in images, the forward pass can include passing a training image through neural network 2200. The weights are initially randomized before neural network 2200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 2200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 2200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 2200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as wᵢ=η dL/dW, where w denotes a weight, wᵢ denotes the initial weight, and n denotes a learning rate. The learning rate can be set to any suitable value, with a high learning rate including larger weight updates and a lower value indicating smaller weight updates.

Neural network 2200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 2200 can include any other deep network other than a CNN, such as an autoencoder, a deep belief nets (DBNs), a Recurrent Neural Networks (RNNs), among others.

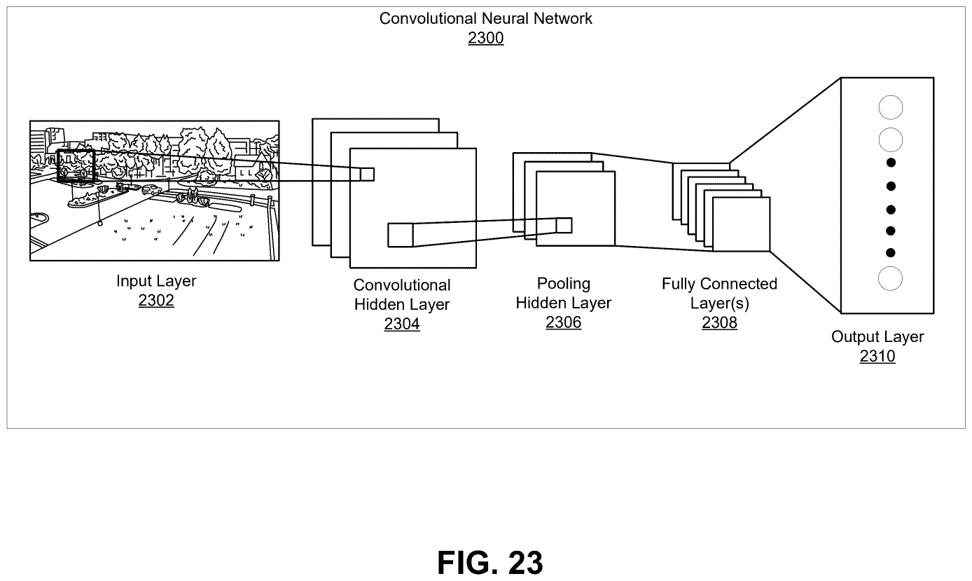

FIG. 23 is an illustrative example of a convolutional neural network (CNN) 2300. The input layer 2302 of the CNN 2300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 2304, an optional non-linear activation layer, a pooling hidden layer 2306, and fully connected layer 2308 (which fully connected layer 2308 can be hidden) to get an output at the output layer 2310. While only one of each hidden layer is shown in FIG. 23, one of ordinary skill will appreciate that multiple convolutional hidden layers, non-linear layers, pooling hidden layers, and/or fully connected layers can be included in the CNN 2300. As previously described, the output can indicate a single class of an object or can include a probability of classes that best describe the object in the image.

The first layer of the CNN 2300 can be the convolutional hidden layer 2304. The convolutional hidden layer 2304 can analyze image data of the input layer 2302. Each node of the convolutional hidden layer 2304 is connected to a region of nodes (pixels) of the input image called a receptive field. The convolutional hidden layer 2304 can be considered as one or more filters (each filter corresponding to a different activation or feature map), with each convolutional iteration of a filter being a node or neuron of the convolutional hidden layer 2304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 2304. Each connection between a node and a receptive field for that node learns a weight and, in some cases, an overall bias such that each node learns to analyze its particular local receptive field in the input image. Each node of the convolutional hidden layer 2304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 2304 is due to each node of the convolutional layer being applied to its corresponding receptive field. For example, a filter of the convolutional hidden layer 2304 can begin in the top-left corner of the input image array and can convolve around the input image. As noted above, each convolutional iteration of the filter can be considered a node or neuron of the convolutional hidden layer 2304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 2304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 2304.

The mapping from the input layer to the convolutional hidden layer 2304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 2304 can include several activation maps in order to identify multiple features in an image. The example shown in FIG. 23 includes three activation maps. Using three activation maps, the convolutional hidden layer 2304 can detect three different kinds of features, with each feature being detectable across the entire image.

In some examples, a non-linear hidden layer can be applied after the convolutional hidden layer 2304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 2300 without affecting the receptive fields of the convolutional hidden layer 2304.

The pooling hidden layer 2306 can be applied after the convolutional hidden layer 2304 (and after the non-linear hidden layer when used). The pooling hidden layer 2306 is used to simplify the information in the output from the convolutional hidden layer 2304. For example, the pooling hidden layer 2306 can take each activation map output from the convolutional hidden layer 2304 and generates a condensed activation map (or feature map) using a pooling function. Max-pooling is one example of a function performed by a pooling hidden layer. Other forms of pooling functions be used by the pooling hidden layer 2306, such as average pooling, L2-norm pooling, or other suitable pooling functions. A pooling function (e.g., a max-pooling filter, an L2-norm filter, or other suitable pooling filter) is applied to each activation map included in the convolutional hidden layer 2304. In the example shown in FIG. 23, three pooling filters are used for the three activation maps in the convolutional hidden layer 2304.

In some examples, max-pooling can be used by applying a max-pooling filter (e.g., having a size of 2×2) with a stride (e.g., equal to a dimension of the filter, such as a stride of 2) to an activation map output from the convolutional hidden layer 2304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 2304 having a dimension of 24×24 nodes, the output from the pooling hidden layer 2306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 2300.

The final layer of connections in the network is a fully-connected layer that connects every node from the pooling hidden layer 2306 to every one of the output nodes in the output layer 2310. Using the example above, the input layer includes 28×28 nodes encoding the pixel intensities of the input image, the convolutional hidden layer 2304 includes 3×24×24 hidden feature nodes based on application of a 5×5 local receptive field (for the filters) to three activation maps, and the pooling hidden layer 2306 includes a layer of 3×12×12 hidden feature nodes based on application of max-pooling filter to 2×2 regions across each of the three feature maps. Extending this example, the output layer 2310 can include ten output nodes. In such an example, every node of the 3×12×12 pooling hidden layer 2306 is connected to every node of the output layer 2310.

The fully connected layer 2308 can obtain the output of the previous pooling hidden layer 2306 (which should represent the activation maps of high-level features) and determines the features that most correlate to a particular class. For example, the fully connected layer 2308 can determine the high-level features that most strongly correlate to a particular class and can include weights (nodes) for the high-level features. A product can be computed between the weights of the fully connected layer 2308 and the pooling hidden layer 2306 to obtain probabilities for the different classes. For example, if the CNN 2300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 2310 can include an M-dimensional vector (in the prior example, M=10). M indicates the number of classes that the CNN 2300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 24 illustrates an example computing-device architecture 2400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2400 may include, implement, or be included in any or all of system 100 of FIG. 1A, system 700 of FIG. 7, system 800 of FIG. 8, system 1000 of FIG. 10, machine-learning model 1200 of FIG. 12, system 1400 of FIG. 14, and/or other devices, modules, or systems described herein. Additionally or alternatively, computing-device architecture 2400 may be configured to perform voxel-block-selection algorithm 1900, process 2000, process 2100, and/or other process described herein.

The components of computing-device architecture 2400 are shown in electrical communication with each other using connection 2412, such as a bus. The example computing-device architecture 2400 includes a central processing unit (CPU or processor) 2402 and computing device connection 2412 that couples various computing device components including computing device memory 2410, such as read only memory (ROM) 2408 and random-access memory (RAM) 2406, to processor 2402.

Computing-device architecture 2400 can include a cache of high-speed memory connected directly with, in close proximity to, or integrated as part of processor 2402. Computing-device architecture 2400 can copy data from memory 2410 and/or the storage device 2414 to cache 2404 for quick access by processor 2402. In this way, the cache can provide a performance boost that avoids processor 2402 delays while waiting for data. These and other modules can control or be configured to control processor 2402 to perform various actions. Other computing device memory 2410 may be available for use as well. Memory 2410 can include multiple different types of memory with different performance characteristics. Processor 2402 can include any general-purpose processor and a hardware or software service, such as service 1 2416, service 2 2418, and service 3 2420 stored in storage device 2414, configured to control processor 2402 as well as a special-purpose processor where software instructions are incorporated into the processor design. Processor 2402 may be a self-contained system, containing multiple cores or processors, a bus, memory controller, cache, etc. A multi-core processor may be symmetric or asymmetric.

To enable user interaction with the computing-device architecture 2400, input device 2422 can represent any number of input mechanisms, such as a microphone for speech, a touch-sensitive screen for gesture or graphical input, keyboard, mouse, motion input, speech and so forth. Output device 2424 can also be one or more of a number of output mechanisms known to those of skill in the art, such as a display, projector, television, speaker device, etc. In some instances, multimodal computing devices can enable a user to provide multiple types of input to communicate with computing-device architecture 2400. Communication interface 2426 can generally govern and manage the user input and computing device output. There is no restriction on operating on any particular hardware arrangement and therefore the basic features here may easily be substituted for improved hardware or firmware arrangements as they are developed.

Storage device 2414 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 2406, read only memory (ROM) 2408, and hybrids thereof. Storage device 2414 can include services 2416, 2418, and 2420 for controlling processor 2402. Other hardware or software modules are contemplated. Storage device 2414 can be connected to the computing device connection 2412. In one aspect, a hardware module that performs a particular function can include the software component stored in a computer-readable medium in connection with the necessary hardware components, such as processor 2402, connection 2412, output device 2424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a digital signal processor (DSP) and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating three-dimensional (3D) data, the apparatus comprising: at least one memory; and at least one processor coupled to the at least one memory and configured to: obtain a plurality of images of a scene; obtain a plurality of camera poses, wherein each image of the plurality of images is captured from a corresponding camera pose of the plurality of camera poses, and wherein each camera pose of the plurality of camera poses comprises a respective position and a respective orientation; determine a plurality of 3D points based on the plurality of camera poses, wherein each 3D point of the plurality of 3D points corresponds to a camera pose of the plurality of camera poses; select a subset of the plurality of images based on positions of the plurality of camera poses and the plurality of 3D points; and generate a 3D representation of the scene based on the subset of the plurality of images and a corresponding subset of the plurality of camera poses.
Aspect 2. The apparatus of aspect 1, wherein, to determine a 3D point of the plurality of 3D points, the at least one processor is configured to project a ray a predetermined distance from a camera pose of the plurality of camera poses to determine the 3D point.
Aspect 3. The apparatus of any one of aspects 1 or 2, wherein, to determine a 3D point of the plurality of 3D points, the at least one processor is configured to project a ray a predetermined distance from a position of a camera pose of the plurality of camera poses in a direction based on the orientation of the camera pose of the plurality of camera poses to determine the 3D point.
Aspect 4. The apparatus of any one of aspects 1 to 3, wherein, to select the subset of the plurality of images, the at least one processor is configured to: combine each 3D point of the plurality of 3D points with a corresponding position of a corresponding camera pose of the plurality of camera poses to generate a plurality of point-and-position pairs; apply a farthest-point-sampling technique to the plurality of point-and-position pairs to select a predetermined number of point-and-position pairs; and identify the subset of the plurality of images based on the predetermined number of point-and-position pairs.
Aspect 5. The apparatus of any one of aspects 1 to 4, wherein, to select the subset of the plurality of images, the at least one processor is configured to: combine each 3D point of the plurality of 3D points with a corresponding position of a corresponding camera pose of the plurality of camera poses to generate a plurality of point-and-position pairs; iteratively identify a point-and-position pair from among the plurality of point-and-position pairs that is farthest from previously-selected point-and-position pairs; and identify the subset of the plurality of images based on the identified point-and-position pairs.
Aspect 6. The apparatus of any one of aspects 1 to 5, wherein, to generate the 3D representation of the scene, the at least one processor is configured to: train a neural radiance field (NeRF) to represent the scene based on the subset of the plurality of images and the plurality of camera poses; and generate a 3D mesh based on the NeRF.
Aspect 7. The apparatus of any one of aspects 1 to 6, wherein, to generate the 3D representation of the scene, the at least one processor is configured to generate a plurality of Gaussian splats to represent the scene based on the subset of the plurality of images and the plurality of camera poses.
Aspect 8. The apparatus of any one of aspects 1 to 7, wherein, to generate the 3D representation of the scene, the at least one processor is configured to use a truncated signed distance function (TSDF) volume to generate the 3D representation of the scene based on the subset of the plurality of images and the plurality of camera poses.
Aspect 9. An apparatus for generating three-dimensional (3D) data, the apparatus comprising: at least one memory; and at least one processor coupled to the at least one memory and configured to: process an input image of a scene using an uncertainty predictor to predict a plurality of uncertainty values; query an implicit neural representation, based on the input image, a camera pose associated with the input image, and the plurality of uncertainty values to generate model outputs; generate a representation of the scene based on the model outputs; determine an error based on a comparison between the input image and the representation; modify parameters of the implicit neural representation based on the error; and modify parameters of the uncertainty predictor based on the error.
Aspect 10. The apparatus of aspect 9, wherein the uncertainty predictor comprises a feed forward network.
Aspect 11. The apparatus of any one of aspects 9 or 10, wherein the at least one processor is configured to select a subset of the plurality of uncertainty values, wherein the implicit neural representation is queried based on the subset of the plurality of uncertainty values.
Aspect 12. The apparatus of any one of aspects 9 to 11, wherein, to query the implicit neural representation, the at least one processor is configured to: identify query pixels of the input image based on the plurality of uncertainty values; generate a ray based on the camera pose the query pixels; identify a number of 3D points along the ray; and query the implicit neural representation regarding the number of 3D points.
Aspect 13. The apparatus of any one of aspects 9 to 12, wherein the implicit neural representation is trained to return, for each query point, at least one of: a color; an opacity; or a signed distance function (SDF).
Aspect 14. The apparatus of any one of aspects 9 to 14, wherein the at least one processor is configured to map the error to pixel coordinates, wherein the parameters of the uncertainty predictor are modified based on the pixel coordinates.
Aspect 15. A method for generating three-dimensional (3D) data, the method comprising: obtaining a plurality of images of a scene; obtaining a plurality of camera poses, wherein each image of the plurality of images is captured from a corresponding camera pose of the plurality of camera poses, and wherein each camera pose of the plurality of camera poses comprises a respective position and a respective orientation; determining a plurality of 3D points based on the plurality of camera poses, wherein each 3D point of the plurality of 3D points corresponds to a camera pose of the plurality of camera poses; selecting a subset of the plurality of images based on positions of the plurality of camera poses and the plurality of 3D points; and generating a 3D representation of the scene based on the subset of the plurality of images and a corresponding subset of the plurality of camera poses.
Aspect 16. The method of aspect 15, wherein determining a 3D point of the plurality of 3D points comprises projecting a ray a predetermined distance from a camera pose of the plurality of camera poses to determine the 3D point.
Aspect 17. The method of any one of aspects 15 or 16, wherein determining a 3D point of the plurality of 3D points comprises projecting a ray a predetermined distance from a position of a camera pose of the plurality of camera poses in a direction based on the orientation of the camera pose of the plurality of camera poses to determine the 3D point.
Aspect 18. The method of any one of aspects 15 to 17, wherein selecting the subset of the plurality of images comprises: combining each 3D point of the plurality of 3D points with a corresponding position of a corresponding camera pose of the plurality of camera poses to generate a plurality of point-and-position pairs; applying a farthest-point-sampling technique to the plurality of point-and-position pairs to select a predetermined number of point-and-position pairs; and identifying the subset of the plurality of images based on the predetermined number of point-and-position pairs.
Aspect 19. The method of any one of aspects 15 to 18, wherein selecting the subset of the plurality of images comprises: combining each 3D point of the plurality of 3D points with a corresponding position of a corresponding camera pose of the plurality of camera poses to generate a plurality of point-and-position pairs; iteratively identifying a point-and-position pair from among the plurality of point-and-position pairs that is farthest from previously-selected point-and-position pairs; and identifying the subset of the plurality of images based on the identified point-and-position pairs.
Aspect 20. The method of any one of aspects 15 to 19, wherein generating the 3D representation of the scene comprises: training a neural radiance field (NeRF) to represent the scene based on the subset of the plurality of images and the plurality of camera poses; and generating a 3D mesh based on the NeRF.
Aspect 21. The method of any one of aspects 15 to 20, wherein generating the 3D representation of the scene comprises generating a plurality of Gaussian splats to represent the scene based on the subset of the plurality of images and the plurality of camera poses.
Aspect 22. The method of any one of aspects 15 to 21, wherein generating the 3D representation of the scene comprises using a truncated signed distance function (TSDF) volume to generate the 3D representation of the scene based on the subset of the plurality of images and the plurality of camera poses.
Aspect 23. A method for generating three-dimensional (3D) data, the method comprising: processing an input image of a scene using an uncertainty predictor to predict a plurality of uncertainty values; querying an implicit neural representation, based on the input image, a camera pose associated with the input image, and the plurality of uncertainty values to generate model outputs; generating a representation of the scene based on the model outputs; determining an error based on a comparison between the input image and the representation; modifying parameters of the implicit neural representation based on the error; and modifying parameters of the uncertainty predictor based on the error.
Aspect 24. The method of aspect 23, wherein the uncertainty predictor comprises a feed forward network.
Aspect 25. The method of any one of aspects 23 or 24, further comprising selecting a subset of the plurality of uncertainty values, wherein the implicit neural representation is queried based on the subset of the plurality of uncertainty values.
Aspect 26. The method of any one of aspects 23 to 25, wherein querying the implicit neural representation comprises: identifying query pixels of the input image based on the plurality of uncertainty values; generating a ray based on the camera pose the query pixels; identifying a number of 3D points along the ray; and querying the implicit neural representation regarding the number of 3D points.
Aspect 27. The method of any one of aspects 23 to 26, wherein the implicit neural representation is trained to return, for each query point, at least one of: a color; an opacity; or a signed distance function (SDF).
Aspect 28. The method of any one of aspects 23 to 27, further comprising mapping the error to pixel coordinates, wherein the parameters of the uncertainty predictor are modified based on the pixel coordinates.
Aspect 29. A non-transitory computer-readable storage medium having stored thereon instructions that, when executed by at least one processor, cause the at least one processor to perform operations according to any of aspects 15 to 28.
Aspect 30. An apparatus for providing virtual content for display, the apparatus comprising one or more means for perform operations according to any of aspects 15 to 28.

What is claimed is:

1. An apparatus for generating three-dimensional (3D) data, the apparatus comprising:
at least one memory; and
at least one processor coupled to the at least one memory and configured to:
obtain a plurality of images of a scene;
obtain a plurality of camera poses, wherein each image of the plurality of images is captured from a corresponding camera pose of the plurality of camera poses, and wherein each camera pose of the plurality of camera poses comprises a respective position and a respective orientation;
determine a plurality of 3D points based on the plurality of camera poses, wherein each 3D point of the plurality of 3D points corresponds to a camera pose of the plurality of camera poses;
select a subset of the plurality of images based on positions of the plurality of camera poses and the plurality of 3D points; and
generate a 3D representation of the scene based on the subset of the plurality of images and a corresponding subset of the plurality of camera poses.

2. The apparatus of claim 1, wherein, to determine a 3D point of the plurality of 3D points, the at least one processor is configured to project a ray a predetermined distance from a camera pose of the plurality of camera poses to determine the 3D point.

3. The apparatus of claim 1, wherein, to determine a 3D point of the plurality of 3D points, the at least one processor is configured to project a ray a predetermined distance from a position of a camera pose of the plurality of camera poses in a direction based on the orientation of the camera pose of the plurality of camera poses to determine the 3D point.

4. The apparatus of claim 1, wherein, to select the subset of the plurality of images, the at least one processor is configured to:
combine each 3D point of the plurality of 3D points with a corresponding position of a corresponding camera pose of the plurality of camera poses to generate a plurality of point-and-position pairs;
apply a farthest-point-sampling technique to the plurality of point-and-position pairs to select a predetermined number of point-and-position pairs; and
identify the subset of the plurality of images based on the predetermined number of point-and-position pairs.

5. The apparatus of claim 1, wherein, to select the subset of the plurality of images, the at least one processor is configured to:
combine each 3D point of the plurality of 3D points with a corresponding position of a corresponding camera pose of the plurality of camera poses to generate a plurality of point-and-position pairs;
iteratively identify a point-and-position pair from among the plurality of point-and-position pairs that is farthest from previously-selected point-and-position pairs; and
identify the subset of the plurality of images based on the identified point-and-position pairs.

6. The apparatus of claim 1, wherein, to generate the 3D representation of the scene, the at least one processor is configured to:
train a neural radiance field (NeRF) to represent the scene based on the subset of the plurality of images and the plurality of camera poses; and
generate a 3D mesh based on the NeRF.

7. The apparatus of claim 1, wherein, to generate the 3D representation of the scene, the at least one processor is configured to generate a plurality of Gaussian splats to represent the scene based on the subset of the plurality of images and the plurality of camera poses.

8. The apparatus of claim 1, wherein, to generate the 3D representation of the scene, the at least one processor is configured to use a truncated signed distance function (TSDF) volume to generate the 3D representation of the scene based on the subset of the plurality of images and the plurality of camera poses.

9. An apparatus for generating three-dimensional (3D) data, the apparatus comprising:
at least one memory; and
at least one processor coupled to the at least one memory and configured to:
process an input image of a scene using an uncertainty predictor to predict a plurality of uncertainty values;
query an implicit neural representation, based on the input image, a camera pose associated with the input image, and the plurality of uncertainty values to generate model outputs;
generate a representation of the scene based on the model outputs;
determine an error based on a comparison between the input image and the representation;
modify parameters of the implicit neural representation based on the error; and
modify parameters of the uncertainty predictor based on the error.

10. The apparatus of claim 9, wherein the uncertainty predictor comprises a feed forward network.

11. The apparatus of claim 9, wherein the at least one processor is configured to select a subset of the plurality of uncertainty values, wherein the implicit neural representation is queried based on the subset of the plurality of uncertainty values.

12. The apparatus of claim 9, wherein, to query the implicit neural representation, the at least one processor is configured to:
identify query pixels of the input image based on the plurality of uncertainty values;
generate a ray based on the camera pose the query pixels;
identify a number of 3D points along the ray; and
query the implicit neural representation regarding the number of 3D points.

13. The apparatus of claim 9, wherein the implicit neural representation is trained to return, for each query point, at least one of:
a color;
an opacity; or
a signed distance function (SDF).

14. The apparatus of claim 9, wherein the at least one processor is configured to map the error to pixel coordinates, wherein the parameters of the uncertainty predictor are modified based on the pixel coordinates.

15. A method for generating three-dimensional (3D) data, the method comprising:
obtaining a plurality of images of a scene;
obtaining a plurality of camera poses, wherein each image of the plurality of images is captured from a corresponding camera pose of the plurality of camera poses, and wherein each camera pose of the plurality of camera poses comprises a respective position and a respective orientation;
determining a plurality of 3D points based on the plurality of camera poses, wherein each 3D point of the plurality of 3D points corresponds to a camera pose of the plurality of camera poses;
selecting a subset of the plurality of images based on positions of the plurality of camera poses and the plurality of 3D points; and
generating a 3D representation of the scene based on the subset of the plurality of images and a corresponding subset of the plurality of camera poses.

16. The method of claim 15, wherein determining a 3D point of the plurality of 3D points comprises projecting a ray a predetermined distance from a camera pose of the plurality of camera poses to determine the 3D point.

17. The method of claim 15, wherein determining a 3D point of the plurality of 3D points comprises projecting a ray a predetermined distance from a position of a camera pose of the plurality of camera poses in a direction based on the orientation of the camera pose of the plurality of camera poses to determine the 3D point.

18. The method of claim 15, wherein selecting the subset of the plurality of images comprises:
combining each 3D point of the plurality of 3D points with a corresponding position of a corresponding camera pose of the plurality of camera poses to generate a plurality of point-and-position pairs;
applying a farthest-point-sampling technique to the plurality of point-and-position pairs to select a predetermined number of point-and-position pairs; and
identifying the subset of the plurality of images based on the predetermined number of point-and-position pairs.

19. The method of claim 15, wherein selecting the subset of the plurality of images comprises:
combining each 3D point of the plurality of 3D points with a corresponding position of a corresponding camera pose of the plurality of camera poses to generate a plurality of point-and-position pairs;
iteratively identifying a point-and-position pair from among the plurality of point-and-position pairs that is farthest from previously-selected point-and-position pairs; and
identifying the subset of the plurality of images based on the identified point-and-position pairs.

20. The method of claim 15, wherein generating the 3D representation of the scene comprises:
training a neural radiance field (NeRF) to represent the scene based on the subset of the plurality of images and the plurality of camera poses; and
generating a 3D mesh based on the NeRF.
